(19) United States
(12) Patent Application Publication
(10) Pub. No.: US 2026/0050897 A1
(43) Pub. Date: Feb. 19, 2026

(54) MANAGING A RESOURCE TRANSFER BASED ON CONDITIONS STORED IN ASSOCIATION WITH A RESOURCE HANDLE INVOLVED IN THE RESOURCE TRANSFER

(71) Applicant: Tyfone, Inc., Portland, OR (US)

(72) Inventors: Nizar Jamal, Bradenton, FL (US); Siva G. Narendra, Portland, OR (US)

(73) Assignee: Tyfone, Inc., Portland, OR (US)

(21) Appl. No.: 19/300,375

(22) Filed: Aug. 14, 2025

Related U.S. Application Data
(60) Provisional application No. 63/683,624, filed on Aug. 15, 2024.
(60) Provisional application No. 63/786,159, filed on Apr. 9, 2025.

(51) Int. Cl. G06Q 20/10

(52) U.S. Cl. CPC G06Q 20/10

(57) ABSTRACT

A computer-implemented method, system, and non-transitory computer-readable media are provided for managing a resource transfer based on conditions stored in association with a resource handle involved in the resource transfer. The resource transfer may have two-sided anonymity, with resource handles and/or token account identifiers in use on either side of the transaction, while still allowing the parties to directly transact with each other without an intermediary. Anonymity, privacy, and fraud prevention may be further strengthened by secure digital mechanisms such as secure protocols, embedded mechanisms such as QR codes or NFC taps for determining resource handle(s), target validation mechanisms, registration and management of reputation scores for resource handles or directory services that manage the resource handles, and use of transaction metadata and derived keys for additional verification.

### CROSS-REFERENCE TO RELATED APPLICATIONS

This application claims the benefit of U.S. Provisional Ser. No. 63/683,624, filed on Aug. 15, 2024 and U.S. Provisional Ser. No. 63/786,159, filed on Apr. 9, 2025. The entire disclosures of the aforementioned applications are incorporated by reference herein in their entireties for all purposes.

### BACKGROUND

Resource transfers occur millions of times per day from account to account by transferring resources from an account number of a first account to an account number of a second account. Parties in possession of account numbers have the potential to perform malicious activity with respect to the corresponding accounts.

In resource transfers that occur so frequently, optimizing usability is critical even though security is also critical. This creates a tradeoff where some digital payment features improve usability at the cost of security while other digital payment features improve security at the cost of usability.

### BRIEF SUMMARY

In some embodiments, a computer-implemented method includes managing a resource transfer based on conditions stored in association with a resource handle involved in the resource transfer.

In one embodiment, a computer-implemented method comprises receiving a request to perform a resource transfer between a first account and a second account. The request originates from a requesting entity and identifies first information sufficient to initiate a transaction with the first account without specifying an identity of the first account, a second resource handle for the second account without specifying an identity of the second account, and a requested amount of a resource to be transferred to or from the second account. The request is routed to a management entity for the second account based at least in part on a second namespace of the second resource handle. The computer-implemented method further comprises processing the request by the management entity for the second account at least in part by identifying, by the management entity, the second account mapped to the second resource handle based at least in part on a mapping stored privately by the management entity and not shared with or accessible to the requesting entity. The computer-implemented method further includes accessing one or more stored conditions specified for and stored in association with the second resource handle. The one or more stored conditions are based on one or more characteristics other than the identity of the first account, and the one or more characteristics are required to have one or more values that must be satisfied in order to approve the resource transfer. The computer-implemented method further includes, based at least in part on determining the one or more stored conditions are satisfied, storing, in association with the second account, information to indicate the resource transfer is in process, and transmitting, to the requesting entity, a particular identifier for the second account. The particular identifier is valid for completing the resource transfer between the first account and the second account. The computer-implemented method further includes receiving an indication that the resource transfer is completed. The indication originated from the requesting entity. The computer-implemented method further includes updating a ledger for the second account to indicate the resource transfer is completed. In an alternative embodiment, receiving the request to perform the resource transfer between the first account and the second account also indicates the resource transfer is in process, and transmitting the particular identifier for the second account indicates the resource transfer was completed.

In a further embodiment, the particular identifier is a token account number for the second account that does not match an official account number for the second account. The token account number is valid for completing the resource transfer between the first account and the second account but not valid for one or more other resource transfers with the second account. The official account number for the second account is valid for the one or more other resource transfers with the second account. In this embodiment, the method further comprises processing the received indication to post the resource transfer against the official account number for the second account based at least in part on determining the token account number is associated with the second account. In a further embodiment, the computer-implemented method further includes invalidating the token account number after receiving the indication that the resource transfer is completed. The official account number for the second account is not invalidated after receiving the indication that the resource transfer is completed.

In the same or a different embodiment, the received indication that the resource transfer is completed identifies a token account number for the first account that does not match an official account number for the first account. The token account number is valid for completing the resource transfer between the first account and the second account but not valid for one or more other resource transfers with the first account. The official account number for the first account is valid for the one or more other resource transfers with the first account. In this embodiment, the method further comprises posting, by the requesting entity, the resource transfer against the official account number for the first account based at least in part on determining the token account number is associated with the first account. In a further embodiment, the computer-implemented method further includes invalidating, by the requesting entity, the token account number after receiving the indication that the resource transfer is completed. The official account number for the first account is not invalidated after receiving the indication that the resource transfer is completed. In another further embodiment, a plurality of token account numbers are stored in association with the first account, and different token account numbers of the plurality of token account numbers are valid for transactions satisfying different configurable conditions stored in association with the first account.

In the same or a different embodiment, the first information comprises a first resource handle and the one or more stored conditions include one or more of:
the resource transfer being initiated by a resource handle matching one or more whitelisted resource handles including the first resource handle,
the resource transfer being initiated by a resource handle not matching one or more blacklisted resource handles excluding the first resource handle and including a third resource handle,
the resource transfer being initiated at a certain time or time range,
the requested amount being within a certain amount or amount range,
an aggregate amount of resource transfers including or excluding the requested amount being within a certain amount or amount range,
an aggregate quantity of resource transfers processed being within a certain quantity or quantity range,
an amount of resources remaining in the second account before the resource transfer being within a certain amount or amount range above zero even though the requested amount would not zero out the second account,
an amount of resources remaining in the second account after the resource transfer projected to be within a certain amount or amount range above zero even though the requested amount would not zero out the second account, or
the resource transfer being initiated by a resource handle having a reputation score within a certain reputation score or reputation score range, wherein the first resource handle is stored in association with the certain reputation score or the reputation score range, or
any combination thereof.

In the same or a different embodiment, the resource transfer is completed without making an existing official and re-usable account number of the second account accessible to an owner of the first account and without making an existing official and re-usable account number of the first account accessible to an owner of the second account.

In the same or a different embodiment, the request is to perform the resource transfer from the second account to the first account, and the one or more stored conditions are limited to pull transfer requests.

In the same or a different embodiment, the request is to perform the resource transfer from the first account to the second account, and the one or more stored conditions are limited to push transfer requests.

In the same or a different embodiment, the first information comprises a first resource handle. The second namespace of the second resource handle is specified as a suffix to the second resource handle, and a first namespace of the first resource handle is specified as a suffix to the first resource handle. The first namespace is managed by a first account management institution associated with the requesting entity, and the second namespace is managed by a second account management institution associated with the management entity. In a further embodiment, the first account management institution manages mappings between tokenized account identities and resource handles for a first set of underlying account identities opaquely to the second account management institution, and the second account management institution manages mappings between tokenized account identities and resource handles for a second set of underlying account identities opaquely to the first account management institution.

In the same or a different embodiment, the second account is stored in association with different resource handles that have different conditions associated with the different resource handles that must be satisfied in order to approve resource transfers using the different resource handles.

In the same or a different embodiment, the first information comprises a first resource handle. The first account is stored in association with different resource handles that have different conditions associated with the different resource handles. At least one of the different resource handles would not satisfy the one or more stored conditions specified for and stored in association with the second resource handle even though the first resource handle does satisfy the one or more stored conditions.

In the same or a different embodiment, the first information comprises a first resource handle. At least one of the first resource handle or the second resource handle is identified based at least in part on a QR code read by a first client device displaying a corresponding one or more of the first resource handle or the second resource handle to a second client device of another party to the resource transfer.

In the same or a different embodiment, the one or more stored conditions indicate a first set of characteristics and values associated with pre-approved resource transfers and a second set of characteristics and values associated with resource transfers that require manual approval.

In the same or a different embodiment, the computer-implemented method further includes tracking a reputation score of the second resource handle, and publishing the reputation score to the requesting entity. In a further embodiment, the reputation score is based at least in part on one or more of:
a number of transactions completed for the second resource handle,
an amount of resources transferred to the second resource handle,
an amount of resources transferred from the second resource handle,
a time the second resource handle has remained in active use, or
one or more reviews provided by one or more owners of other resource handles involved in resource transfers with the second resource handle, or
any combination thereof.

In the same or a different further embodiment, the computer-implemented method further includes requesting an update to the reputation score from the requesting entity based at least in part on the resource transfer, and updating the reputation score based at least in part on feedback received from the requesting entity.

In the same or a different further embodiment, the computer-implemented method further includes detecting potentially fraudulent activity associated with the second resource handle based at least in part on the reputation score, and, based at least in part on detecting the potentially fraudulent activity, disabling the second resource handle without requesting permission from an account owner of the second account.

In the same or a different further embodiment, the received indication that the resource transfer is completed identifies a token account number for the second account that does not match an official account number for the second account, and the token account number is valid for completing the resource transfer between the first account and the second account but not valid for one or more other resource transfers with the second account. The official account number for the second account is valid for the one or more other resource transfers with the second account. The computer-implemented method further includes posting, by the management entity, the resource transfer against the official account number for the second account based at least in part on determining the token account number is associated with the second account. In a further embodiment, a plurality of token account numbers are stored in association with the second account, and different token account numbers of the plurality of token account numbers are valid for transactions satisfying different configurable conditions stored in association with the second account. In a particular further embodiment, a plurality of resource handles are stored in association with at least one token account number of the plurality of token account numbers that are stored in association with the second account, and different resource handles of the plurality of resource handles are valid for transactions satisfying different configurable conditions stored in association with the second account.

In the same or a different further embodiment, a plurality of resource handles are stored in association with the first account, and different resource handles of the plurality of resource handles are valid for transactions satisfying different configurable conditions stored in association with the first account.

In the same or a different further embodiment, a plurality of resource handles are stored in association with at least one token account number of the plurality of token account numbers that are stored in association with the first account, and different resource handles of the plurality of resource handles are valid for transactions satisfying different configurable conditions stored in association with the first account.

In one embodiment, a computer-implemented method comprises receiving from a merchant entity a request to enroll in a resource transfer service. The computer-implemented method further includes verifying an identity and account information of the merchant entity. The computer-implemented method further includes generating a resource handle specific to the merchant entity for use in transactions with consumers, and providing the merchant entity with access to a portal for managing transactions, setting conditions, and tracking resource transfers.

In one embodiment, a computer-implemented method comprises receiving, from a consumer entity, a request to initiate a resource transfer to a merchant entity. The request identifies a resource handle associated with the merchant entity. The computer-implemented method further includes processing the resource transfer request by verifying one or more conditions set by the merchant entity, and completing the resource transfer upon satisfaction of the one or more conditions. The computer-implemented method further includes notifying the merchant entity and the consumer entity of a status of the resource transfer.

In a further embodiment, the computer-implemented method further includes enabling the merchant entity to set specific conditions for resource transfers, including accepted payment methods, transaction limits, and/or real-time payment notifications.

In one embodiment, a computer-implemented method includes transmitting a request to perform a resource transfer between a first account and a second account. The request originates from a requesting entity and is transmitted to a target entity. The request identifies first information sufficient to initiate a transaction with the first account, a second resource handle for the second account without specifying an identity of the second account, and a requested amount of a resource to be transferred to or from the second account. The request is routed to a management entity for the second account based at least in part on a second namespace of the second resource handle. The computer-implemented method further includes receiving a particular identifier for the second account in association with the transaction associated with the first information. The particular identifier originated from the target entity and is valid for completing the resource transfer between the first account and the second account. The computer-implemented method further includes using the first information to identify a ledger associated with the first account. The computer-implemented method further includes transmitting an indication that the first account has been updated.

The indication originates from the requesting entity. The computer-implemented method may further include receiving another indication that the resource transfer is completed if a ledger for the second account is updated after the indication is transmitted. In an alternative embodiment, receiving the particular identifier for the second account in association with the transaction associated with the first information includes receiving another indication that the resource transfer is in process, and transmitting the indication indicates the resource transfer was completed by the requesting entity.

In a further embodiment, the requesting entity may determine the second resource handle for the second account textually, by scanning a QR code, or via an NFC tap, and the requesting entity may determine the target entity based at least in part on the second resource handle. For example, the requesting entity may determine the target entity based at least in part on a prefix, suffix, or other part of the second resource handle.

In various embodiments, a computer-program product comprises one or more non-transitory machine-readable storage media, including stored instructions configured to cause a computing system to perform a set of actions including any of the methods described herein or any combination thereof.

In various embodiments, a system comprises one or more processors and one or more non-transitory computer-readable media storing instructions, which, when executed by the system, cause the system to perform a set of actions including actions including any of the methods described herein or any combination thereof.

The subject matter disclosed, which utilizes secure, condition-based processing and resource handle management methods as described herein, is not limited to financial institutions but can be implemented by any trusted party or a neutral consolidator trusted by multiple entities. It facilitates secure, compliant, and technologically enhanced transactions involving any digital asset, value, or asset exchange between unrelated and potentially untrusting parties.

As used herein, the terms “first,” “second,” “third,” and “fourth” are used as naming conventions in order to separately refer to items or entities that otherwise may share the same name. These naming conventions are not intended to imply ordering constraints unless such ordering constraints are otherwise specified using terms such as “before” or “after,” or unless such ordering constraints are otherwise contained within the logical description, such as determining a target for communication before communicating with the target.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that manages a resource transfer based on one or more conditions stored in association with a resource handle involved in the resource transfer.

FIG. 2 illustrates a system diagram showing an example system that manages a resource transfer based on one or more conditions stored in association with a resource handle involved in the resource transfer.

FIG. 3A illustrates a diagram of an example user interface showing initiating a resource transfer using a specified resource handle.

FIG. 3B illustrates a diagram of an example user interface showing configuration of condition(s) for sending and/or receiving resources.

FIG. 4 illustrates an example user interface for initiating a resource transfer from a mobile device.

FIGS. 5 and 6 illustrate example user interfaces for initiating resource transfers from a laptop and/or a mobile device.

FIG. 7 illustrates an example diagram of an example architecture for approving or rejecting a resource transfer to a specified resource handle.

FIG. 8 illustrates a diagram of a distributed system for managing a resource transfer based on one or more conditions stored in association with a resource handle involved in the resource transfer.

FIG. 9 illustrates an example computer system that may be used to manage a resource transfer based on one or more conditions stored in association with a resource handle involved in the resource transfer.

FIG. 10 shows an example application user interface that includes a capture region for scanning a QR code, and the QR code is scanned to show encrypted payment information that was encoded in the QR code.

FIG. 11 shows an example updated interface where a requested transaction (or, in the example, an invoice or resource transfer request) is being serviced from a location (e.g., the payment from location) that has been verified as having a valid certificate (identified as a Secure Payment Request in indicator).

FIG. 12 shows an example payment processing interface resulting from a selection of a “Pay” option on the example interface of FIG. 11.

### DETAILED DESCRIPTION

Techniques are described for managing a resource transfer based on conditions stored in association with a resource handle involved in the resource transfer. The resource transfer may have two-sided anonymity, with resource handles and/or token account identifiers in use on either side of the transaction, while still allowing the parties to directly transact with each other without an intermediary. Anonymity, privacy, and fraud prevention may be further strengthened by secure digital mechanisms such as secure protocols, embedded mechanisms such as QR codes or NFC taps for determining resource handle(s), target validation mechanisms, registration and management of reputation scores for resource handles or directory services that manage the resource handles, and use of transaction metadata and derived keys for additional verification.

A description of managing a resource transfer based on one or more conditions stored in association with a resource handle involved in the resource transfer is provided in the following sections:
RESOURCE TRANSFER ARCHITECTURE
HIERARCHICAL RESOURCE TRANSFER ARCHITECTURE
AUTHENTICATION, ENCRYPTED COMMUNICATION, AND ACCOUNT TOKENIZATION
RESOURCE HANDLE MANAGEMENT ENTRIES
TRANSACTION COMPLETION
SECURE RESOURCE TRANSFER USING EMBEDDED SYSTEMS
DIRECTORY SERVICE VERIFICATON
TRANSACTION METADATA, KEYWORD TUPLES, AND HIERARCHICAL METADATA
ACCOUNT NUMBER TOKENIZATION AND DE-TOKENIZATION
FINANCIAL INSTITUTION REGISTRATION
EXAMPLE INTERFACE FOR INITIATING RESOURCE TRANSFERS
EXAMPLE PAYMENT INTERFACE
EXAMPLE INTERFACE FOR MANAGING RESOURCE HANDLE PERMISSIONS
RESOURCE HANDLE REPUTATION-AS-A-SERVICE
FRAUD DETECTION
SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Resource Transfer Architecture

Resource transfers, such as payments or movements of digital assets or other electronically accessible resources, may be made between individuals or entities using push payments or push transactions where the sender provides a combination of routing number (e.g., Routing Transit Number, “RTN,” or American Banker's Association number, “ABA”, typically 9 digits, often matching the number that would be printed on a check corresponding to a group of accounts from a financial institution) and account number (typically 9-12 digits, often matching the number that would be printed as the second numbers from the left on the bottom of a check corresponding to the account) or other identifying information of a recipient to send money or move digital assets or other electronically accessible resources to the recipient, or pull payments or other pull transactions where the recipient provides a combination of routing number and account number of a sender or other identifying information of a sender to send money to the recipient. Payments may involve cash, cash equivalents, or cryptocurrency. Digital assets or other electronically accessible resources may include cryptocurrency, non-fungible tokens (NFTs), or other digital assets for which ownership may be established. In one example for cash transactions, the automated clearing house (ACH) network allows banks or other financial institutions to transfer resources between each other using a protocol, either as a direct deposit (credit) or direct payment (debit).

For example, with push payments, the sender initiates the payment by giving instructions to a financial institution to transfer funds to another account by identifying the other account (for example, by routing number and account number). The sender's financial institution communicates with an ACH network via an ACH protocol and sends payment information (including the sender's account information, the receiver's account information, the amount to be transferred, and other optional or required information or instructions) to a receiving financial institution. The receiving financial institution then adds money to the receiver's account from the sender's account by identifying the accounts using the corresponding account numbers. Push payments allow the payer to initiate the transfer, meaning that the recipient can disclose an identity. If the identity can also be used to withdraw funds from the recipient, the recipient may be at risk by exposing such identity information.

As another example, with pull payments, the receiver initiates the payment by giving instructions to a financial institution to transfer funds from another account by identifying the other account (e.g., for Visa®, MasterCard®, checks, and/or ACH, for example, by routing number and account number). The receiver's financial institution communicates with the ACH network via an ACH protocol and transmits payment information (including the receiver's account information, the sender's account information, the amount to be transferred, and other optional or required information or instructions) to the sending financial institution. The sending financial institution then adds funds to the receiver's account from the sender's account by identifying the accounts using the corresponding account numbers. These pull payment mechanisms effectively expose the funding source by requiring the party requesting funds to know the payer's account details. Such information, if compromised, could be used to withdraw money in a fraudulent or mistaken manner. This creates an inherent vulnerability that is difficult to mitigate, even with tokenization.

In pull payment systems, the payer's identity is disclosed to the recipient. This type of disclosure is not secured against withdraw because the identity is disclosed for the purpose of performing a withdraw from where the money is located. In contrast, in a push payment system, the sender needs to know the recipient's account information. In various embodiments described herein, such as embodiments using secure resource handles, such information can only receive money and cannot be used to take money.

ACH positive pay is a mechanism that allows the sender to confirm that the amounts requested to be sent are amounts that should actually be sent and/or that the amounts to be sent are to the party that should actually receive the amounts. The confirming account holder may confirm the amounts before the payment is later triggered in a batch payment as instructions sent to the financial institution upon or after confirmation. The financial institution of the confirming account holder, and/or another financial institution involved in the transaction, may place same or different time limits on when the approval or rejection of the transaction must be provided, such as 30 seconds, 30 minutes, or 3 hours. Transaction amounts may be pre-approved with a specific format or code such that transactions initiated with the format or access code may be approved without further confirmation.

Real Time Payments (RTP) may also be used to accomplish transfers via an electronic payment rail that almost instantly acknowledges the transfer. While ACH payments may settle in batches, the RTP transfer typically costs per transaction with the benefit of settling immediately. Any type of resource transfer is supported by the techniques described herein.

Some resource identity directory services, such as Tyfone® Instant Payment Exchange or Zelle®, use an identity directory to protect the routing number and account number of the sender and recipient. Payments sent using a resource identity directory service identify a recipient using an identifier of the recipient. The resource identity directory service matches the identifier to a routing number and account number and completes the payment to the target recipient without sharing the account number or the routing number with the sender. In one example, a resource identity directory service may store a global directory of account identifiers (e.g., phone numbers and/or email addresses) of individual members and uses a 3-digit number to indicate which member financial institution an individual member belongs. The 3-digit number is used to generate a token for transmitting a payment to the member at the corresponding financial institution without sharing details about the specific member with the transaction initiating financial institution. In this manner, identifiers such as email addresses, phone numbers, or usernames can be used to receive money rather than by the recipient sharing her or his account number. In this example model, when the resource identity directory service manages a global mapping for individual members, the financial institutions of the individual members as well as the members themselves are not in control of permissions to access the individual account. Also, if a member wants to use an individual identifier, such as an email address or phone number, with different financial institutions, the individual member may be forced according to this model to select which financial institution to use in association with the global identifier.

Unlike the Tyfone® Instant Payment Exchange or Zelle®, resource transfer services like Venmo® or PayPal® support transfers between individuals and a virtual fund managed on behalf of the individuals. The virtual fund is in control of Venmo® or PayPal®, and resources managed in the virtual fund may be withdrawn only according to the restrictions and control of the centralized fund. For example, Venmo® may allow users to pay a fee to absorb some of the risk of a quicker withdrawal from a Venmo® account, or may provide a slower path for users to make a withdrawal or transfer from the Venmo® account. This virtual fund approach does not immediately hit an actual account owned and controlled by the user as raw resources but instead is managed within Venmo® as a virtualized resource that may be converted into raw resources at a later time. Transactions are marked as complete when the virtual fund of Venmo® has received a resource transfer, even though the end-user has only received virtualized funds managed by Venmo® for later conversion into raw resources. Unlike the Tyfone® Instant Payment Exchange or Zelle®, Venmo® and other virtual funds do not offer a routing number or account number that can be used to complete transactions and does not offer paper checks, e-checks, or other support that treats completed transactions as raw transferrable resources that are not limited to any particular virtual environment or fund. That is because the virtual funds are centralized, manage their own risks, and often charge fees for the purpose of risk management and profit. On the other hand, account-to-account transactions normally do not carry fees and are a basic service of account ownership. Even if account-to-account transactions carry fees, funds are transferred immediately from one account to another, recorded against a financial institution's master account at the central bank and against each party's individual (actual) bank account in the core banking ledger for the financial institution, without being stored in an intermediate virtual fund that manages the exchange.

For instant payment embodiments, unlike Venmo®, the directory service serves as an information intermediary service to identify the actual ledger against which the transaction will be recorded (and after which point the full transaction is complete between the parties), but the actual ledger controlled by a transacting party is where the transaction is recorded instead of a virtual ledger to hold the funds on behalf of the transacting party until later withdrawn to an actual ledger.

In one embodiment, a resource identity directory service resolves identifier(s) such as payment addresses or other resource handles, to a recipient or sender in a potential one-to-one or many-to-one mapping between resource handles and recipients with a variety of possible permissions applied to the resource handle(s). The resource handles support peer-to-peer, peer-to-business, and peer-to-government payments where the peers do not need to be members of the same financial institution. Resource handle(s) or prefix(es) thereof may be chosen by the account owner with resource handle suffix(es) or other namespace(s) associated with the account owner's financial institution. In this manner, account owners may use same or similar prefixes for different financial institutions, and the prefixes may be combined with financial institution suffixes, namespaces, or other identifying parts to form a resource handle that identifies the individual's account at the specific financial institution without revealing the account number for that financial institution.

The use of a resource handle (such as a different account number, payment address text, or QR code) enables fund transfers to be controlled by the party sharing the transfer information. For example, in push payment systems, the resource handle may allow funds to be received but not withdrawn via the resource handle. The use of the secure resource handle allows disclosed identities to be decoupled from account ownership such that disclosed identities cannot be used for unintended purposes (e.g., to withdraw funds instead of receive funds). The secure resource handles prevent either party in a transaction from needing to expose their underlying account information, even when the resource handle (e.g., via a QR code, different account number, or payment address text) is shared, promoting privacy and security for both parties. This allows the disclosed identities to be used safely in public contexts. By doing so, the secure resource handles redefine how trust and privacy can be preserved in open payment ecosystems without compromising on accessibility or scale.

Further, resource handles using a hierarchical namespace may scale like a domain name space (DNS) directory, with account owner group prefix namespaces being added to bank, bank division, and/or region suffixes. Further subdivision of banks or regions may be accomplished by adding further suffixes to the namespace, with transactions occurring within a given region or bank or bank division not needing to use the additional suffixes to complete the transaction and transactions occurring outside the given region or bank or bank division adding the suffixes to complete the transaction with respect to the correct account in the correct region at the correct bank division.

In one embodiment, multiple directories may be developed independently for separate financial institutions, with the different directories managing payment address prefixes for institution-controlled payment address suffixes so that a payment address with a suffix associated with a target financial institution may be resolved by contacting a directory service associated with the target financial institution.

Unlike centralized systems such as Visa®, MasterCard®, or Zelle®, the resource handle mechanism is institution-agnostic and may be used to accomplish transactions between institutions without incurring additional fees imposed by a centralized actor. Each institution involved in the transaction would coordinate transaction restrictions and fees with account holders of the institution and without having to pay another institution unnecessary transaction fees. Further, the account holders themselves may configure the resource handles such that unnecessary transactions are avoided and transaction fees are mitigated even with their own financial institution. This payments architecture is different from toll-based system and instead promotes governance of financial transactions by the account owner and the financial institution of the account owner rather than by a centralized other actor, even though multiple different financial institutions may use the same resource handle mechanism to cause transactions within and between financial institutions.

The resource handle architecture described herein is a privacy-first infrastructure for open, scalable push payments, not just a better aliasing system. The resource handle architecture solves a real identity-protection problem that current systems cannot solve.

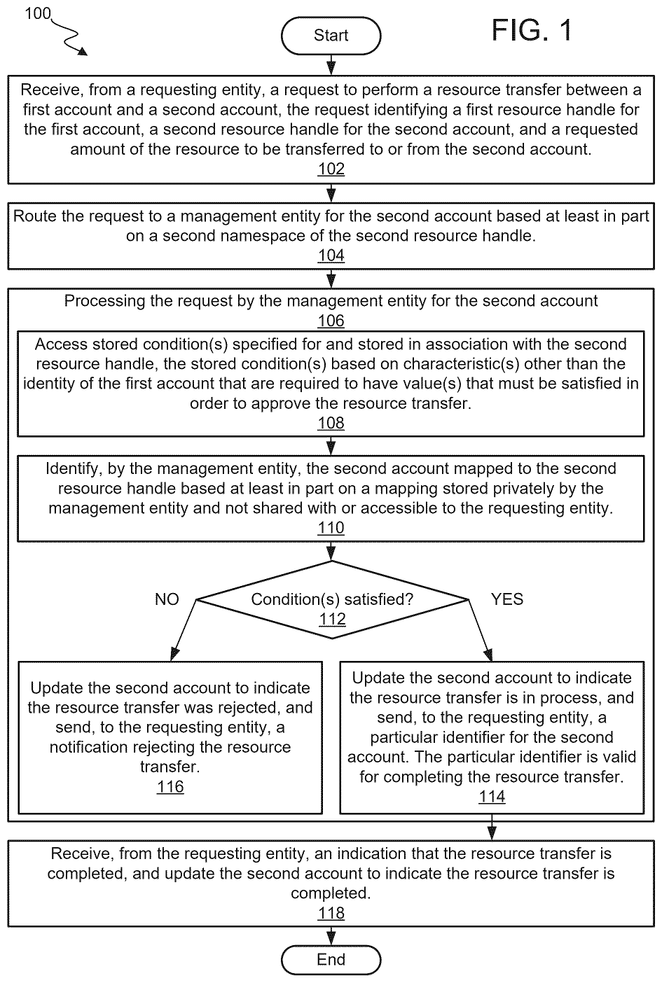

FIG. 1 illustrates a flow chart of an example process 100 that manages a resource transfer based on one or more conditions stored in association with a resource handle involved in the resource transfer. As shown, in block 102, a request is received from a requesting entity. The request is to perform a resource transfer between a first account and a second account. The request identifies a first resource handle for the first account, a second resource handle for the second account, and a requested amount of the resource to be transferred to or from the second account. In block 104, the request is routed to a management entity for the second account based at least in part on a second namespace of the second resource handle. In block 106, the request is processed by the management entity for the second account. Block 106 includes block 108, which includes accessing stored condition(s) that are specified for and stored in association with the second resource handle. The stored condition(s) are based on characteristic(s) other than the identity of the first account that are required to have value(s) that must be satisfied to approve the resource transfer. Block 106 further includes block 110, where the management entity identifies the second account mapped to the second resource handle based at least in part on a mapping stored privately by the management entity and not shared with or accessible to the requesting entity. Block 106 further includes block 112, where a determination is made as to whether stored condition(s) are satisfied. If the stored condition(s) are satisfied, block 106 proceeds to block 114, where the second account is updated to indicate that the resource transfer is in process, and a particular identifier for the second account is sent to the requesting entity. The particular identifier is valid for completing the resource transfer. If the stored condition(s) are not satisfied, block 106 proceeds to block 116, where the second account is updated to indicate that the resource transfer was rejected, and a notification is sent to the requesting entity that the resource transfer is rejected. Process 100 proceeds to block 118, where the management entity receives, from the requesting entity, an indication that the resource transfer is completed, and the second account is updated to indicate that the resource transfer is completed.

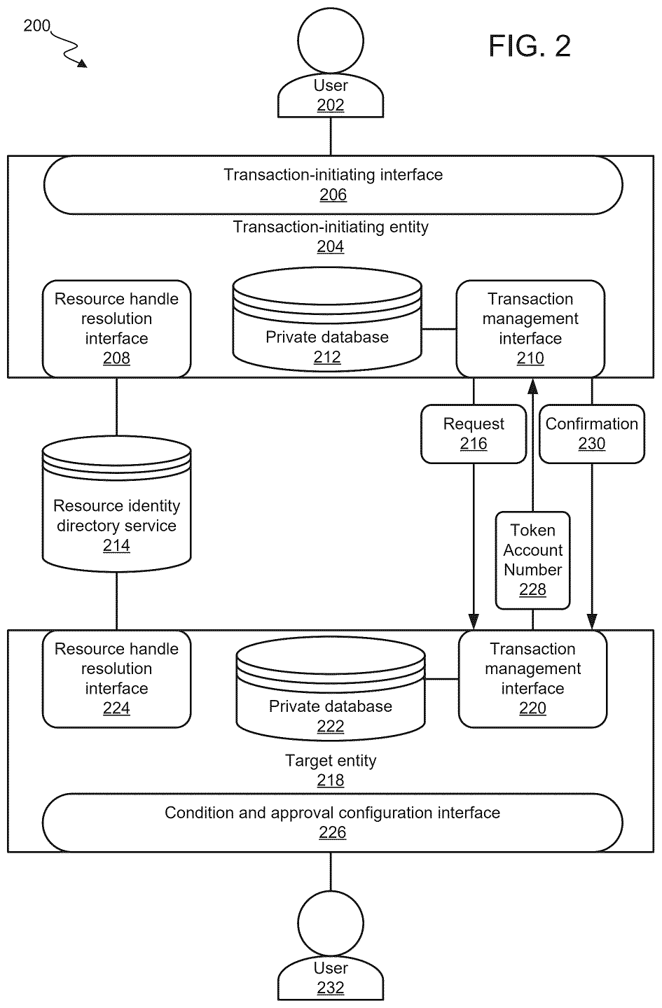

FIG. 2 illustrates a system diagram showing an example system 200 that manages a resource transfer based on one or more conditions stored in association with a resource handle involved in the resource transfer. As shown, user 202 interactions with transaction-initiating interface 206 of transaction initiating entity 204 to initiate a transaction with a target resource handle managed by target entity 218. Resource handle resolution interface 208 uses resource identity directory service 214 to determine that the transaction relates to a resource handle managed by target entity 218, for example, based on a namespace of the target resource handle. Transaction-initiating entity 204 may then, through transaction management interface 210, transmit a request 216 to target entity 218 to initiate the transaction. Request 216 is received by target entity 218 through transaction management interface 220. Target entity 218 may check stored condition(s) in private database 222 to determine if the transaction satisfied the condition(s) or not. If the transaction satisfies the condition(s), a token account number 228 is returned to transaction-initiating entity 204.

Transaction management interface completes the transaction using the token account number 228 and transmits a confirmation 230 to target entity 218 such as by updating a shared ledger. Target entity 218 also includes a condition and approval configuration interface 226, which may be used to create or update the stored condition(s) and/or to provide manual approval(s) when such approval(s) are required by the stored condition(s). As shown, target entity 218 also includes a resource handle resolution interface 224 to determine entities that manage other resource handles. As shown, transaction-initiating entity 204 also includes private database 212 for managing stored condition(s) in association with resource handles managed by transaction-initiating entity 204.

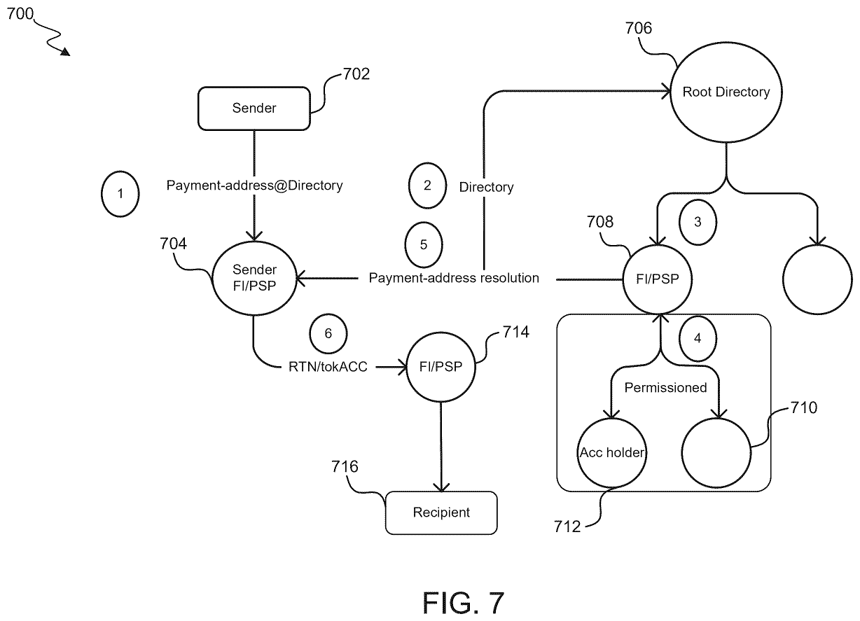

FIG. 7 illustrates an example diagram of an example architecture 700 for approving or rejecting a resource transfer to a specified resource handle. As shown, a sender 702 initiates a resource transfer using a payment address, “payment-address@Directory.” The payment address has a prefix, “payment-address,” that identifies a shared resource transfer target of a target account holder and a suffix, “Directory,” that identifies a target financial institution. A sender financial institution or payment service provider 704 determines the target financial institution or payment service provider 708 using a root directory 706, and a request for the resource transfer is passed to the target financial institution 708.

The target financial institution 708 determines whether the resource transfer is allowed or disallowed based on permissions 710 stored in association with the target resource handle for a target account holder 712. If the resource transfer is allowed, the target financial institution 708 returns, to the sender financial institution 704, a payment address, such as the actual account number or a transformed, temporary, or otherwise tokenized version of the account number and a routing number of the target financial institution. The financial institution 714 sending payment may then initiate a direct transfer to recipient 716 using the payment address. Use of a tokenized account number may be selected, via a resource handle configuration user interface, by a user configuring settings for the resource handle or the corresponding account in push scenarios, pull scenarios, or both scenarios. In another embodiment, the user may selected, via the resource handle configuration user interface, to use an actual account number in push scenarios, pull scenarios, or both scenarios. The sender financial institution 714 records the transaction against the routing number of the target financial institution and the account number or tokenized account number. The target financial institution 708 updates the target account holder's balance based on the recorded transaction, and the sender financial institution records the sender account holder's balance based on the recorded transaction, such that the transferred resources reach the intended recipient.

In one embodiment, the system integrates with existing financial infrastructure (e.g., automated clearing house (ACH), real-time-payments (RTP), and/or blockchain transaction ledgers) and merchant systems (e.g., point-of-sale (POS) systems and e-commerce platforms. The resource handles may be recorded against accounts using existing resource transfer protocols with the addition of the routing and permission management of resource handles, as well as the secure, private, computing efficient, and potentially time-limited addition of a token account number generated for a corresponding resource handle once a corresponding resource transfer has been approved or otherwise made available for use with the resource handle once the resource transfer has been approved. Such added security, privacy, and computing efficient operations use the pseudo-random, guaranteed unique token account numbers combined with the security, privacy, and efficiency benefits of the resource handles to achieve a synergy across resource transfers that results in transfers that can be completed without additional communication round-trips but also without sharing details that can be used in the wrong hands to maliciously attack the corresponding computer systems.

Permissions or other stored condition(s) may be applied to each resource handle to restrict activity associated with that resource handle, and such permissions may be stored by the financial institution using an application for managing permissions. In the absence of specified permissions, default permissions of a financial institution managing the resource handle may be applied to the resource handle. Resource handles may be created with default or non-default permissions applied on the creation of the resource handle without other non-selected permissions being applied initially. In other words, the resource handles may be configured with permissions before the resource handles become live and useable for resource transfers.

Enforcement of resource handle permissions could extend to ‘smart contracts’ where the resource handle, utilizing the secure, condition-based processing methods described herein, facilitates transactions involving any digital asset. This enables exchanges of value or assets between two unrelated and potentially untrusting parties, with the financial institution ensuring compliance with predefined conditions through technologically secure processes.

In various embodiments, conditions may be enforced automatically, regardless of complexity and regardless of the use and reliance on external information. For example, conditions may be based on information retrieved using a stored application access token for a merchant or other party's database to retrieve information about an identifier received as metadata in association with a pending resource transfer request. The token may be used to authenticate to the third party's database, and information may be retrieved in association with the identifier to verify that one or more conditions are satisfied or not. Condition logic may combine multiple different call-outs to multiple different third party databases and/or information retrieved from the resource transfer request itself. Such condition logic may combined conditions using conjunctions, disjunctions, or any nested combination of conjunctions and/or disjunctions. In one embodiment, the financial institution or other service provider imposes limits on a number of different conditions that may be imposed for a given transaction, and different numbers of conditions may be imposed for different accounts, or different resource handles of different accounts, based on a free or paid tier of the account holder and/or based on balance amounts in account(s) of the account holder.

For a given resource handle involved in a given payment attempt, the suffix of the resource handle may be resolved by the resource identity directory service to a financial institution associated with the resource handle suffix in a stored directory of financial institutions associated with resource handle suffixes. For example, “usbank” in “scott@usbank” may be resolved to a financial institution named US Bank associated with a particular 9-digit routing number.

The resource handle prefix may then be passed to the financial institution to resolve the payment attempt to or from an individual account. For example, “scott” in “scott@usbank” may be resolved to a 12-digit account number. Other resource handle prefixes may be email addresses or email address prefixes of the account holder, a phone number of the account holder, a QR code, or any other identifier associated with the account holder that does not reveal the account holder's account number.

### Hierarchical Resource Transfer Architecture

In various embodiments, the prefix of the resource handle may specify the account or the financial institution, and the suffix may specify another of the financial institution or the account. In this manner, the account information may be said to be specified within a path as a portion of the resource handle, and the financial institution, account manager, or directory service may be specified within the path as a different portion of the resource handle. In some embodiments, the path includes a node nested within a hierarchy of other nodes, where each ancestor in the hierarchy serves as a directory service for the descendants of the ancestor in the hierarchy such that the ancestor is responsible for verifying that the lower-level nodes in the hierarchy exist and are valid targets for transactions. In this manner, financial institutions may serve as high-level directory services while organizations maintaining accounts on the financial institutions may serve as lower-level directory services to verify that individual accounts they own, or sub-accounts of those accounts, are still valid targets for transactions. Permissions may be configurable at each level of the hierarchy to control what types of transactions are valid at the lower-level nodes and may be used to determine whether a transaction is authorized to proceed as far as the level of hierarchy is concerned. In this manner, transactions may be approved at a higher level of the hierarchy by a higher level directory service but rejected at a lower level of the hierarchy by a lower level directory service, pursuant to rules that are specific to individual accounts or sets of accounts within a higher level financial institution.

The directory service provider for each node in the hierarchy may serve as the validator for identities below the level of the directory service provider, as well as the validator that transaction conditions managed by that directory service provider, if any, have been satisfied for any transactions that pass beyond the directory service provider to a target. In some embodiments, whether or not a transaction is allowed to pass beyond the directory service provider to the target is determined using a machine learning model trained to detect conspicuous transactions and flag or prevent the conspicuous transactions from even reaching a set of rules configured by the account holder. The models, rules, or conditions configured at each level may be determined by the entity controlling the level, which may be a financial institution, an account manager, etc. In this way, tiered conditions or other checks may be configured for different directory service providers in a hierarchy to prevent conspicuous activity from even being exposed to logic configured by the individual account holder (referred to herein as the resource handle management entry or the configurable rules entry specific to and stored in association with a resource handle). This bottom level or leaf nodes of the hierarchy control access to the individual account numbers or tokenized account numbers. For example, a resource handle “john_smith.group2.division1.companyA.bankofamerica” may be provided to identify an account of an individual (e.g., John Smith) in a group (e.g., 2) of a division (e.g., 1) of a company (e.g., A) that holds an account at a financial institution (e.g., Bank of America). In the example, the resource handle may be validated by a Bank of America directory service, followed by a Company A directory service, followed by a Division 1 directory service, followed by a Group 2 directory service, followed by the configurable rules specified by John Smith for his resource handle. At each step along the path, the directory services validate identities of the next level before passing the request along to the next level. In other words, Bank of America would validate that “Company A” is a valid account holder of Bank of America before passing the request along to the directory service for Company A, and Company A would validate that Division 1 is a valid division of Company A before passing the request along to Division 1. The validation may be done with certificates and/or via form(s) of identification.

In one example, for a request for a transaction from a Chase account to a Bank of America account, the certificate that may be passed to initiate the transaction may be a Chase-granted certificate received by Bank of America, and the Chase-granted certificate may validate to Bank of America that the requesting entity has been certified and validated by Chase even though Bank of America did not grant the certificate to the requesting entity.

In addition, third parties are protected by the directory service providers using KYC (Know Your Customer) by verifying that the account owner is a real person with the identity claimed and is not engaged in fraudulent, criminal, or high-risk activity. By passing a third party request along to the account holder, the directory service is validating that the account holder is fit to deal with third parties.

### Authentication, Encrypted Communication, and Account Tokenization

In one embodiment, the financial institution may map the resource handle prefix to an individual account and provide a temporary or permanent proxy account number or transformed or otherwise tokenized account number to use for payment to or from the individual account. For example, the tokenized account number may be generated based on a one-way hash of the actual account number, where the financial institution is the only entity or among a private set of entities that has a stored mapping back to the actual account number. As another example, the tokenized account number may be an input into an account generating function that checks existing account numbers and ensures that the tokenized account number is unique among all account numbers at the financial institution and that also injects randomness (such as using a hash or a random number generator) into the generation of the tokenized account number.

Communications between financial institutions or service providers are encrypted, for example, using tunneled traffic to ensure that even tokenized versions of account numbers cannot be ascertained from outside parties. With the added levels of protection of encrypted traffic between financial institutions, tokenization of the account number, logical separation between the account number and the resource handle, and potentially time-variant conditions, specifiable and modifiable by the account holders and tracked and enforced by the corresponding financial institution or service provider, various resource transfer systems described herein provide data security, privacy, efficiency, network security, and resource control improvements that are unparalleled using other techniques. Despite long-felt but unsolved needs for secure resource exchanges, the state of the art fails to accomplish these synergistic approaches to data security, privacy, efficiency, network security, and resource control.

A transaction initiator (often a sender pushing funds but sometimes a recipient pulling funds) interacts with the transaction initiator's financial institution to initiate a financial transaction between the transaction initiator's financial institution and another involved financial institution. The transaction initiator's financial institution may provide a user interface, for example, via a browser or an application on a mobile device, for account holder(s) at the financial institution. In a session with the application via a browser using secure https communications, a user may authenticate and further communicate with a server, such as a server owned by the financial institution. Additionally or alternatively, authentication may occur using OAuth 2.0, biometric authentication from a device, two-factor authentication, or using another authorization technique that allows a device or third party service to verify that the user is able to authenticate to an account having a shared email address or other user identifier.

In various embodiments, a level of authentication of the user may depend on an activity being performed by the user or requested to be performed by the user in the browser. For example, a user is requesting to view a balance or see basic account information may be subjected to a first layer of authentication, and a user requesting to change account settings, create or modify tokenized account numbers or resource handles, change conditions to be checked for the tokenized account numbers or resource handles, change notification settings for the tokenized account numbers or resource handles, or perform other account-level administrative actions may be subjected to another layer of authentication. For example, two-factor authentication may be used for such account-level administrative actions while a single login may be sufficient for basic account-level read operations. The two-factor authentication may include one or more steps of additional validation that the user is in control of an email address or phone number associated with the account, is in possession of a PIN for the account, or has other additional proof that the user is the owner of the account. The level(s) and mechanism of authentication used may be determined dynamically by the institution's authentication server based on actions being performed in the system and based on what information is already known about the user (e.g., the user is using a device normally used to access the account, a browser recently used to access the account, has biometrically authenticated with the service, for example, using an image of the user's face or eyes or a reading of the user's thumbprint, or has provided a PIN uniquely specified for the account).

The user interface may provide options to send or request money from the transaction initiator's financial institution or another involved financial institution. An account holder of the transaction initiator's financial institution may provide the resource handle of another account holder, including a prefix identifying the other account holder and a suffix identifying the other financial institution of the other account holder. The transaction initiator's financial institution may transmit a transaction message including the resource handle to a resource identity directory service for resolution, or may otherwise consult the resource identity directory service for resolution of the address. For example, the resource identity directory service may be provided by the Federal Reserve, a consortia of financial institutions, or another trusted financial service provider, for example, as an open directory for consumption by financial institutions, or as a directory restricted only to verified financial institutions (such as 8,000-9,000 verified financial institutions in the U.S.) and inaccessible to others. In one embodiment, the resource identity directory service is managed as a distributed blockchain service among a plurality of financial institutions with a majority voting mechanism or veto mechanism for verifying changes to ensure that resource handle suffix or namespace to financial institution mappings are accurately maintained. In another embodiment, the resource identity directory service is managed by a service that gives ownership over namespaces or suffixes based on which routing numbers are covered by those namespaces or suffixes and which financial institution(s) own the routing numbers. The resource identity directory service or a directory thereof may resolve the resource handle suffix to identify the other financial institution, and the transaction message may be passed to the other financial institution to resolve the other account holder from the prefix of the resource handle.

The transaction message that is passed from the transaction initiator and the transaction message that is sent to the other financial institution may refer to the transaction initiator with a corresponding resource handle of the transaction initiator, such that the account number of the transaction initiator does not need to be exposed to the other financial institution. The transaction message also includes the resource handle of the other account holder that is a member of the other financial institution. The other financial institution may resolve the prefix of the resource handle of the other account holder to identify the other account holder and proceed to execute the transaction or not based on the permissions stored in association with the resource handle for the other account holder.

### Resource Handle Management Entries

In various embodiments, resource handle management entries for resource handles may be used to manage configurable rules on either side or both sides of a transaction, the sender and/or the recipient. For example, the sender may have limitations specified in association with a sender's resource handle that limit what type of transactions are allowed for the sender's resource handle, with what timing, and/or to what extent, and/or the recipient may have limitations specified in association with a recipient's resource handle that limit what type of transactions are allowed for the recipient's resource handle, with what timing, and/or to what extent. If conditions are specified on both sides, in either push or pull payment scenarios, the conditions of one of the sender (push) or recipient (pull) may be checked before initiating the transaction and requesting completion and the conditions of another of the recipient (push) or sender (pull) may be checked after the transaction is initiated but before the transaction is allowed to be completed.

When the other financial institution receives a transaction message requesting to initiate a transaction with the other account holder, the other financial institution may check the stored permissions of the other account holder to determine whether to proceed with the transaction or not, or what additional steps to take. The stored permissions may be stored in association with the resource handle, and the other account holder may have different permissions stored in association with different resource handles that have been set up and are in concurrent use by the other account holder. The other account holder may have stored permissions that indicate a pre-approval, synchronous approval, or asynchronous approval for specific transactions optionally of specific amounts or ranges of amounts (e.g., with upper and/or lower bounds), optionally of specific quantities of transactions or up to specific aggregate amounts, and optionally to or from specific other resource handles. Permissions are stored by the other financial institution in association with account holders such as the other account holder, and the relevant permissions may be retrieved for the other account holder before approving or rejecting the requested transaction. For example, the other account holder, scott@usbank, may indicate a pre-approval for a $100 transaction with an account holder identified as jane@bankofamerica, and this pre-approval may be used to clear or reject the transaction requested by the transaction message depending on whether the conditions for approval in the stored permissions are met or not.

The other account holder may have other accounts identified by other addresses, such as “scottwork@usbank,” “scottfamily@usbank,” “scottfriends@usbank,” or “storefrontXYZ@usbank,” where the pre-approval is not indicated in the stored permissions and/or where other conditions are present in the stored permissions. The permissions may indicate conditions not only on pulling money out of an account but additionally or alternatively on pushing money into an account. For example, a setting for a particular resource handle associated with an account may include a stored permission indicating that money is only to be received from pre-identified whitelisted resource handles and that all other deposits are to be rejected for the particular resource handle. Other resource handle(s) may be associated with the same account and indicate that money can be received by any sender regardless of whether the sender's resource handle has been pre-identified. The other resource handle(s) may be subject to other conditions, such as payment amount or frequency limits, times of day, or excluding blacklisted resource handles such as those known to be associated with fraud.

If the transaction is cleared, in the example, a ledger may be updated to reflect a debit or credit to the other financial institution (e.g., usbank) on behalf of the other account holder's account (e.g., scott's account), and a corresponding ledger may be updated to reflect a credit or debit to the financial institution (e.g., bankofamerica) on behalf of the account holder's account (e.g., jane's account).

Various conditions in the stored permissions give the financial institution and the account holder more control over how money is transferred to or from the account holder's account. For example, the financial institution may have default conditions that apply to all account holders, such as not to accept pull requests for accounts. The default conditions may be overridden by an account holder who had decided to allow pull requests from a specific other account.

In various embodiments, depending on the permissions set up for the account, the resource identity directory service may be bypassed even for an account that has resource handle(s) set up. The resource identity directory service may be bypassed using an actual routing and account number of the other account holder, if such information has been provided. In one embodiment, a transaction initiated with the actual routing and account number may bypass the permissions set up for the account to cause the transaction to be completed. In another embodiment, the transaction initiated with the actual routing and account number may be blocked, and payments to and/or from the account may be accessible only using a tokenized account number.

In this manner, configuring accounts to use secure resource handles and optionally to selectively prevent or allow transacting parties from using underlying account numbers to initiate transactions prevents either transacting party in a transaction from needing to expose their underlying account information, even when the resource handle (e.g., via a QR code, different account number, or payment address text) is shared and even if underlying account information is otherwise compromised, promoting privacy and security for both parties.

In one embodiment, the permissions for an account holder indicate that all requests satisfying certain characteristics (e.g., dollar amounts, ranges, dates, specific senders or recipients, etc.) or all requests regardless of characteristics may be flagged for manual review by the account holder. In this embodiment, a transaction initiated by a transaction initiating account holder may be sent to another financial institution that identifies another account holder. The other account holder may have a stored permission indicating that manual review is required for the transaction, in which case the other financial institution prompts the other account holder for review in the form of an approval or rejection of the pending transaction. The other account holder may indicate, in response to a prompt on a mobile device or other device, via an application, email, or text message, for example, triggered by the other financial institution, whether the transaction is approved or rejected. While the other account holder is reviewing the prompt, the transaction may be held as incomplete by both the initiating financial institution and the other financial institution. The financial institutions may place their own limits on an amount of time that an incomplete transaction may be held as incomplete before the transaction is marked as failed, and such limits may also be configurable (e.g., by adjusting up or down by seconds or minutes) by account holders of those financial institutions within overall limits (e.g., 15, 20, 25, 30 (e.g., an instant payment threshold), 35, 40, 45 50, 55, or 60 seconds, or 5, 10, 20, 30, 40, 50, 60, 90, 120, 180, or 240 minutes) set by the financial institutions. In various embodiments, the account holder may specify a default action, such as to accept the transaction or to reject the transaction, when the time limit expires.

In a resource transfer system that supports pull payments, a directory service cannot be a fully open directory without additional verification and control. Otherwise, any party could potentially pull payments from any account. In various embodiments, the directory service serves as a guard on information about the underlying account to ensure that only those parties with access to a resource handle, however specified (e.g., textually, as a QR code, or via an NFC tap), have the ability to request of a particular directory service to obtain access to the account, and the directory service may grant or deny that access based on configurable rules specified as a resource handle management entry (also called an “alias entry”) for a resource handle (also called an “alias”) associated with an account, and the configurable rules may depend on an identity of the entity requesting the access and/or based on timing, amounts, and/or other factors.

In a particular embodiment, the other factors may include, among potential authorized parties, parties that accessed resource transfer information from certain channels. For example, the domain service may store information, in association with a particular resource handle, that indicates parties accessing encrypted resource transfer information using a certificate may be authorized in addition to other specific parties accessing resource transfer information regardless of whether such information was obtained through encrypted channels or not. In other words, some trusted entities may be able to initiate transactions directly using unencrypted textual resource handles, while other entities may still be able to initiate transactions using QR codes that contain encrypted resource transfer information that was decrypted using a certificate such as one shared with a trusted directory provider.

The configurable rules may alternatively specify how much deference to provide to another trusted directory provider in determining whether or not to allow such payment to occur. For example, the configurable rules may specify a minimum acceptable trust level as determined by the other trusted directory provider, identity verification criteria, or other criteria as determined by the other trusted directory provider that are prerequisites to initiating the transaction, and the other trusted directory provider may indicate whether the criteria is satisfied or not. This allows trust to be shifted between parties in favor of overall transaction efficiency or in favor of closely controlled fraud prevention.

### Transaction Completion

Once the other financial institution has cleared the transaction to proceed, the other financial institution may provide a routing number and account number, such as a transformed or otherwise tokenized account number, to the initiator's financial institution so that payment may be performed to or from the transformed or tokenized account number from the other financial institution, from or to the account number or a transformed or tokenized account number of the transaction initiator. The initiator's financial institution may provide the account number or a transformed or otherwise account number of the other account holder to the other financial institution to complete the transaction between the initiator's account and the other account holder's account. For example, the initiator's financial institution may cause a debit or credit ledger to be updated with the transaction for the other financial institution and a credit or debit ledger to be updated with the transaction for the initiator's financial institution.

The other financial institution may generate tokenized account numbers to represent individual account numbers and may reverse the mapping between tokenized account numbers back to individual account numbers to complete a transaction against the individual account. In this manner, the account number does not need to be exposed between financial institutions, such that financial institutions are not privy to account numbers of account holders at other financial institutions. Without actual account numbers, financial institutions cannot initiate transactions unless the tokenized account number is known, and the tokenized account number may be temporary and may be periodically or synchronously, in line with completing transactions, updated for individual accounts to prevent re-use of even a tokenized account number.

With or without use of the tokenized account numbers, the actual account number may not be exposed to the transaction initiator or the other account holder as members of their corresponding financial institutions. The financial institutions may handle the transaction based on the resource handles without exposing the underlying account numbers to their members.

In one embodiment, a resource handle may be a single-use or otherwise temporary-use resource handle that can be used only once, a limited number of times, and/or for a limited period of time. The temporary-use resource handle may be managed in the stored permissions of the financial institution managing the temporary-use resource handle, to ensure that a token account number generated for the temporary-use resource handle becomes invalid after the token account number has been used the limited number of times or once the time period has expired. Any further transactions attempting to use the temporary-use resource handle or the token account number may be rejected as invalid and optionally flagged as potentially fraudulent.

In another embodiment, a resource handle may be valid until revoked by an account holder. The resource handle may be used to send and/or receive payments by the account holder using one or more token account numbers associated with the resource handle, optionally cycled periodically, until the account holder indicates to the account holder's financial institution that the resource handle should be revoked or that the resource handle should be further restricted. The token account number(s) in use for the resource handle may be invalidated upon the account holder's indication that the resource handle should be revoked or subject to further restrictions, and any further transactions attempting to use the revoked token account number(s) may be rejected and optionally flagged as potentially fraudulent.

If a transaction initiator attempts to push or pull resources to an invalid resource handle, or beyond the scope of permissions of a valid resource handle, or using an invalid account number, the invalid resource handle and/or invalid account number may still be sent in association with a valid financial institution. If a valid financial institution is identified, the valid financial institution may review the attempted transaction and reject the attempted transaction as invalid. A response message may be sent back to the initiating financial institution, and the initiating financial institution may cause display of a message to the initiating account holder that the attempted transaction was rejected, optionally indicating that the resource handle or account number were invalid if such information is provided by the valid financial institution and if such information is opted to be forwarded to the initiating account holder by the initiating financial institution.

### Secure Resource Transfer Using Embedded Systems

In various embodiments, embedded systems are used to facilitate resource transfer. For example, resource transfer functionality may be embedded into QR codes readable by scanners embedded in mobile devices, NFC taps or tags readable by NFC readers embedded in mobile devices, bluetooth or other wireless communication accessible via wireless receivers embedded in mobile devices, and/or other communications accessible via tools embedded in mobile, wearable, or other computing devices.

In one embodiment, QR codes are used to facilitate resource transfer between parties. The QR code may be secured with an embedded image in the QR code and/or by using an intermediary that ensures the QR code maps to a valid directory provider entity, such as one that matches an intended target as represented in the embedded image. The embedded image may boost consumer confidence, and an identity of the target represented by the QR code may then be verified when the QR code is scanned. The secured QR code may provide assurance that the QR code is matched to a valid directory provider rather than a spoofed provider that is attempting to serve as a fraudulent target for transaction(s). In one example, a QR code may be verified based on contrast, modulation, axial non-uniformity, unused error correction, and/or fixed pattern damage according to ISO/IEC 15415 and/or ANSI/AIM ITS/04-2000 (R2015). The QR code may also be evaluated based on data encoding rules, symbol structure and versioning, error correction levels (L, M, Q, H using Reed-Solomon codes), data masking, alignment, and format info, data encoding modes (numeric, alphanumeric, byte, Kanji, etc.), symbol versions and sizes, data capacity, and/or quiet zone requirements according to ANSI ISO/IEC 18004:2006 QR code standards and/or ANSI INCITS 446-2008 QR code standards. Verification of the QR code using these various standards ensures the QR code is reliably readable and structured according to specification to identify an electronic reference target.

Even if the QR code points to a reliable target, the reliable target may not correspond with a valid directory provider if the QR code has been provided in fraudulent circumstances (e.g., such as swapping in a QR code that points to a fraudulent target in place of a valid QR code that points to a valid directory provider). Because the QR code provides a more automated mechanism for resource transfer, the QR code may be used even in the absence of a physical presence of either party to the transaction. A verification service may guard against another party with a physical presence interfering with a valid transaction, for example, by substituting fraudulent information to represent an absent party as if the substituted information were previously provided by the absent party. The verification service may verify the QR code is using valid certificates to ensure the directory provider's identity has been validated and that the directory provider identified can be trusted. The verification service may further use the ANSI X9 standard to verify secure sensitive payment data (like PAN, CVV, expiration date) in retail and payment ecosystems. The X9 standard protects cardholder data at rest and in transit, covers encryption, key management, and access controls. In particular, the X9 standard determines how payment target information is tokenized with a token that maps only within a secure system and has no value if stolen. The verification service may apply the X9 standard to help ensure that any payment-related info provided or received is tied to a known, validated entity (e.g., an issuing bank or processor). The verification service may further apply the X9.119 standard to use cryptographic controls, certificates, and secure key management to ensure that payment data originated from a trusted, authorized source, tokens are issued and resolved only by a certified token service provider (TSP), and communication with the TSP uses mutual authentication. This ensures the origin of payment data can be verified before acceptance.

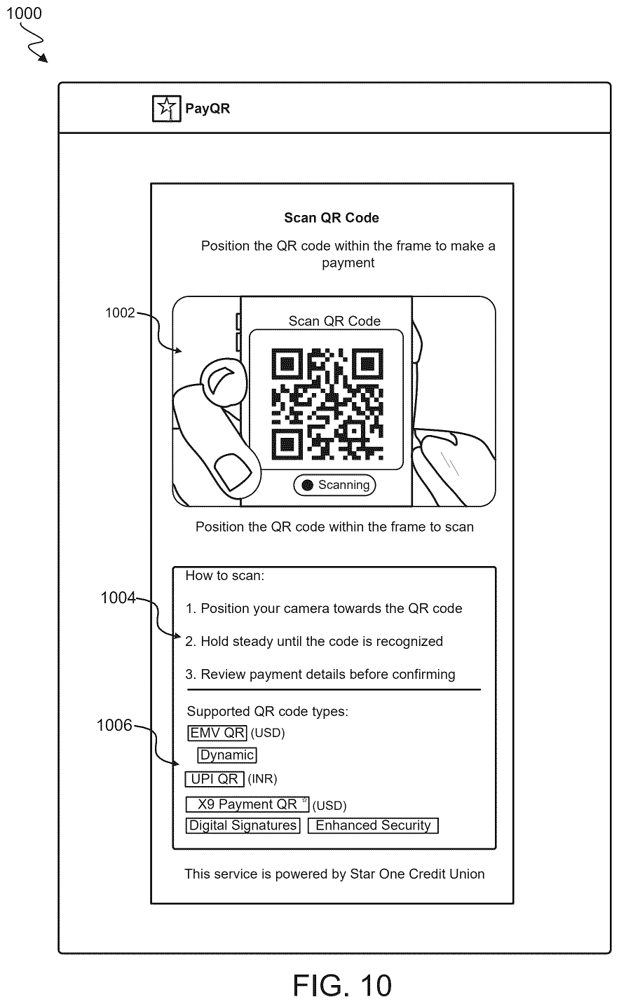

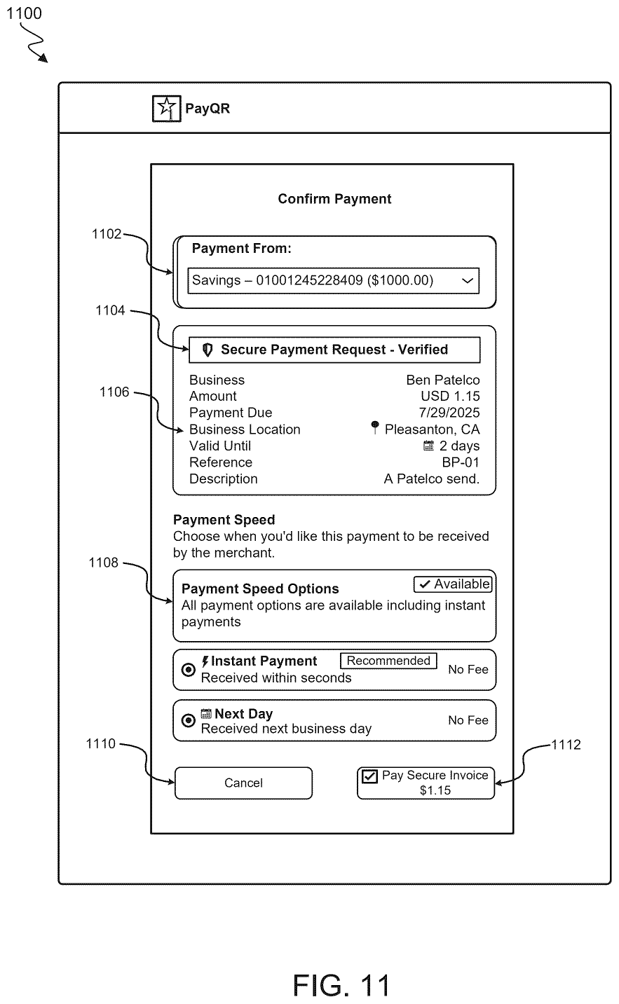

The QR code may be certified by a directory provider certification authority, and the verification service may verify that the QR code is among certified QR codes stored or otherwise identified in association with valid directory services. In various embodiments, the QR code may be encrypted such that a standard (non-certified) QR code scanner will not be able to validate the QR code as a valid target for a resource transfer, but a verification service that has access to a certificate used to encrypt the QR code may decrypt the QR code into a valid target for a resource transfer after verifying that the valid target is using a directory service among a set of valid directory services. To a non-certified QR code scanner without a certificate, the scanned QR code may appear as an encrypted jumble of bits that does not resolve to a valid URL, let alone a valid URL that identifies valid resource transfer information or a valid resource handle. For example, a non-certified scanner attempting to scan the QR code of FIG. 10 may be directed to a Google search for the following string of characters “00020101021226890006org.x90175api.ipx.local:8444/x9/payment-requests/ 3a5212a5-922d-4ec9-a0d2-8bf6c9d1f0ec52040000530384054041.155802US5911Ben Patelco6010Pleasanton63048C89” rather than the secure payment request information shown in FIG. 11. In this example, the certificate authority validating the certificate may determine that the characters are to be evaluated on Google. com unless otherwise specified. If the certificate authority is configured to analyze the characters using a different certificate, the payment request information from FIG. 11 may be displayed. In this manner, the QR code may be used to establish a valid payment as long as the payment is passing through the verification service.

As shown in FIG. 10, an example application user interface 1000 includes a capture region 1002 for scanning a QR code, and the QR code is scanned to show encrypted payment information that was encoded in the QR code. Example interface 1000 also shows instructions 1004 for how to scan and supported QR code types 1006 for the scan. The information is encoded using an extension of the Europay, Mastercard, Visa (EMV) standard to show, in an updated interface example illustrated in FIG. 11, that a requested transaction (or, in the example, an invoice or resource transfer request) is being serviced from a location (e.g., the payment from location 1102) that has been verified as having a valid certificate (identified as a Secure Payment Request in indicator 1104). The encoded information may also include other information 1106, such as business, amount, payment due, business location, valid until date, reference, and/or description of the invoice (possibly including line item details). In various examples, EMV QR codes may include information including a payload format indicator, merchant account info, transaction amount(s), country and currency codes, cyclic redundancy check (CRC) for integrity, a merchant category, and/or terminal identifier, etc. Some of the information may be encoded in the QR code and/or other portions of the information may be retrieved from a URL or location that is determined from the QR code.

A verification service supporting the user interface of FIGS. 10-11 is able to determine that an endpoint of the transaction is verified as having a valid certificate. The X9 and/or ANSI standards allow embedding of cryptographic data (such as digital signatures and/or secure tokens) within a QR code, allowing verifiers to authenticate that the QR code's source is legitimate and untampered. The embedded cryptographic data may include a digital signature, a hash of the payload, and/or a reference to a certificate (e.g., using a public key infrastructure—PKI). This allows a QR code to be verified cryptographically as being created by a known, trusted entity and makes the QR code resistant to spoofing or unauthorized reproduction. If the QR code contains tokenized payment data issued by a certified token service provider, then only that token service provider can de-tokenize the data and confirm the origin of the data. The public key infrastructure may allow a public key to be embedded in or referenced by the QR code, and the QR payload may be signed using a private key. A QR code scanner may use the public key to verify authenticity of the message.

Embedded cryptographic data may include data that is encrypted to ensure that only a recipient with a shared certificate, key, password, or other shared secret may be able to read the information and initiate a transaction using the information. In one embodiment, retrieval of information embedded in the QR code from a URL may be limited to only those endpoints that have a shared certificate, key, password, or other secret, such that the transaction details and other metadata about the proposed transaction are not visible to a third party without the shared secret. Applications serving other recipients without the shared secret may not be able to read unencrypted resource transfer information that would otherwise be necessary to complete the transaction. In this manner, payments may be initiated between two parties using published QR code and a shared certificate, key, password, or other secret between the parties.

### Directory Service Verificaton

A verification service may be established as a trusted application on either or both sides of a transaction to ensure that directory services along the paths to the endpoints correspond to valid directory services, but different verification services may be used for different financial institutions or sets of financial institutions such that no single financial institution is forced to trust another financial institution's verification service.

Different sides of the transaction may also use different verification services controlled by different financial institutions as long as a certificate has been shared between the verification services for the purpose of cross-validating that references to each other's directory service are valid. In this manner, the QR codes for some financial institutions may be decrypted using information from one certificate, and QR codes for other financial institutions may be decrypted using information from another certificate, with the corresponding certificate to use being identified based on metadata for the QR code (e.g., for targets associated with known directory services) or within the QR code or resource handle itself as a non-encrypted portion of the QR code or resource handle. In this manner, financial institutions and directory services may choose which other financial institutions and directory services to trust by choosing which directory services with which to share certificates and which directory services with which not to share certificates.

A unified certification authority may also be used to simplify the process for different financial institutions and directory services, with options to cross-validate resource handles for directory services based on directory service quality ratings. For example, a directory service may choose to cross-validate resource handles (and thus share certificates) only with those other directory services that are rated 8/10 or above or 7/10 or above on a rating scale that measures how much fraud is associated with the other directory services. The unified certification authority may receive reports of fraudulent activity from any directory service and update ratings for the corresponding directory services based on how many transactions were non-fraudulent, how many transactions were reported fraudulent, and/or how many reports of fraud came from the directory service (e.g., to guard against fraudulent reports of fraud). The ratings determined and used by the unified certification authority for sharing certificates among entities may also discourage financial institutions from passively allowing fraudulent activity to occur within their directory service, as such activity will negatively impact the rating of the financial institution and may negatively impact the ability of members of the financial institution to freely engage in transactions with members of other financial institutions using resource handles or encrypted resource transfer information that relies on shared certificates.

In one embodiment, whether or not a unified certification authority is used, a directory service may certify the identity of an account owner before establishing an account that can be transacted with by third parties using resource transfer information (such as resource handles) and before granting a certificate to transact with the account. The certification process may include analyzing forms of identification (e.g., driver's license, passport, official mail, etc.) of the account holder or even requesting a physical meeting with the account holder. The directory service may revoke an account-specific certificate for the account if the directory service determines that the account has been the cause of a fraudulent transaction, is creating confusion among account holders (e.g., a “StarOneCredit” resource handle may be revoked in light of another account holder “StarOneCreditUnion” that already exists), that a confidence has decreased or is below a threshold for the account holder's identity, or for other reasons.

The directory provider may be verified even in non-QR code implementations (e.g., a textual resource handle that specifies the account and domain, an NFC tap that specifies the account and domain, etc.). Whether or not QR codes are used to specify a source or target of a resource transfer, various entities may provide different aliases or identities as targets for payments contingent on verifying the directory provider resolving the different aliases or identities has been verified to be a valid directory provider. If resources need to be passed between entities, the entities on either side of the transaction may be verified to be valid targets by the directory provider as well as by further validating an identity of a directory provider in good standing as a non-fraudulent directory provider.

### Transaction Metadata, Keyword Tuples, and Hierarchical Metadata

In various embodiments, resource transfer information may be encrypted via a URL, NFC tap, QR code, resource handle text, or other transaction initiating tool. The encrypted resource transfer information may be pulled directly from the transaction initiating tool and/or may be pulled or supplemented from a source identified by the transaction initiated tool. In one embodiment, encrypted resource transfer information, once decrypted, may include not just a resource handle with account information and financial institution information for resolution by a directory service provider, but may also include other transaction metadata such as secret keywords, a passcode, or other information that may be verified by a party to the transaction as valid keywords. In this manner, either party to the transaction may receive the keywords along with a request to initiate or complete the transaction and verify that the keywords were correctly decrypted from the original encrypted resource transfer information. This validates that the other party to the transaction not only has the right resource handle but also had access to the certificate when decrypting originally decrypted information.

Either party to transactions may update the encrypted resource transfer information periodically to ensure the secret keywords, passcode, or other information used for verification purposes changes over time, and that there is no static mechanism that can be used to fraudulently assume the party's identity in a transaction. In one embodiment, a resource transfer information publisher is configured to cycle through different keywords or tuples (e.g., 2, 3, 4, etc.) of keywords from a configurable dictionary of keywords at a configurable time period for the cycle. In this manner, the party posting encrypted resource transfer information may be ensured that the resource transfer information will require access to a shared certificate and not just outputs determined using the shared certificate in order to establish a transaction. In various embodiments, the resource transfer information publisher may be notified of a change in membership of a certificate community that has access to the certificate of the resource transfer information publisher, and, in response to the change in membership may update the encrypted resource transfer information to use different secret keywords, passcodes, or other information for verification purposes, and/or may update the certificate itself to be shared only with the new certificate community (after the modification).

In one embodiment, multiple levels of encrypted transaction information may be used to establish a single transaction. In this manner, the transaction may be verified using hierarchical metadata. For example, a first level of encrypted transaction information may be used at a higher level to validate that the transaction is approved from a financial institution's perspective, and a lower level of encrypted transaction information may be used to validate that the transaction is approved from an account owner's perspective or from the perspective of rules applied to a set of accounts (or another child or descendant of the higher level validation node). The higher level transaction information may be decrypted and validated by the higher level entity, such as a financial institution, after the higher level entity has approved the transaction based on rules accessible to the financial institution, and further encrypted lower level transaction information, which may be nested within the decrypted higher-level transaction information, may be passed on to a lower level entity, such as an entity managing a set of accounts, to further validate the transaction from the lower level entity's perspective with access to the lower level entity's configurable rules. The lower level entity may validate or invalidate the transaction and communicate with the higher level entity (or up the chain of approval entities, optionally with information about further approvals from descendant nodes in the case of a deep hierarchy) that the transaction has been approved or rejected. Once approved, the higher level entity may allow the transaction to proceed using the information received from the lower level entities.

When the transaction is completed, transaction metadata may be stored in association with the transaction against a resource handle, and the transaction metadata may be used by the parties to verify that the transaction occurred as expected. For example, if a party indicated that the metadata should include a tuple of keywords (e.g., such as one configurable by the party), the other party may verify that the metadata includes the tuple of keywords even if the transaction itself was not made dependent on the tuple of keywords being part of the transaction. In this manner, the parties may have a personalized and secure way of verifying that transactions occurred with the parties they expected the transactions to occur with.

### Account Number Tokenization and De-Tokenization

In various embodiments, use of the tokenized account number does not expose security issues that may otherwise be exposed by account to account transfers. Account to account transfers may use actual account numbers, in which case the sender possesses the account number (e.g., checking account number, card number, etc.) for sending or receiving money from the account. Such information may be used to illegitimately extract resources from the account (e.g., using the same number). With a tokenized account number, on the other hand, the tokenized account number may be generated for a user-configured use-case or a use case configured by the institution that owns or manages the underlying account. The tokenized account number may be useable for transfers that satisfy conditions associated with the use case but not for transfers that do not satisfy conditions associated with the use case. For example, if the use case it to receive money in small amounts, the token may be useable to receive transfers that do not exceed a certain amount. In this scenario, knowledge of the tokenized account number may not be used to extract resources from the account because the conditions limit the tokenized account number to receiving resources that do not exceed a certain amount. The institution managing the tokenized account number may check the tokenized account number to determine which uses have been configured for that tokenized account number and block transactions that exceed any boundaries or otherwise do not satisfy conditions configured for the tokenized account number.

Rather than using the actual account number to identify the ledger to be debited or credited, an institution controlling the ledger may use a pre-configured tokenized account number generated for limited use in debiting and/or crediting the ledger when certain conditions are satisfied. The conditions may be specified and stored in association with the tokenized account number in a tokenized account configuration repository managed by the institution that controls the account. The tokenized account configuration repository may store account information for an individual user or may store account information for all users or a set or group of users of the institution that controls the accounts. A user of the institution may access the user's accounts and/or tokenized account numbers and configure which condition(s) are to be checked when resources are attempted to be credited and/or debited to the accounts and/or tokenized account numbers.

If the condition(s) are satisfied for resources being credited to and/or debited from a tokenized account, the resources may be credited and/or debited from an actual account identified internally by the institution controlling the accounts. A confirmation message may be sent to an entity requesting the resource transfer, and the confirmation message may use the tokenized account number rather than the actual account number. In this manner, the actual account number is masked externally to the institution but used internally within the institution to manage which ledger is being credited and/or debited.

In various embodiments, a routing number may be used to identify the institution for which resources are being requested to be debited or credited. An account number used for a requested transaction may be a tokenized account number that is limited, by condition(s) configured by a user who own resources in the account and stored in association with the tokenized account number, to debit(s) and/or credit(s) for the tokenized account number that satisfy the condition(s). If the condition(s) are satisfied, the institution managing the account may use the tokenized account number to determine the actual underlying account number and complete the transaction by updating an account balance for the underlying account based on a transaction reported against the tokenized account number.

In one embodiment, the tokenized account number and virtual account number may share a suffix but differ in a prefix. For example, a real account number may be 0012345678, and a tokenized account number may be 1053225678. In this example, the tokenized account number may share the suffix 5678 with the real account number but may differ in a prefix. Sharing a suffix may allow for more efficient management of an address space associated with account numbers, with a fewer number of possibilities for potential address collisions between tokenized account numbers. In another example, the tokenized account number does not share a suffix with the real or underlying account number but instead is randomly or pseudo-randomly generated in full or using a different part of the account number. In yet another example, the tokenized account number is assigned a prefix that is designated for tokenized account numbers and not actual or underlying account numbers.

Managing the address space for tokenized account numbers separately from actual account numbers may promote efficient processing of transactions that are directed to actual account numbers without encumbering the transactions with the condition-checking mechanism associated with tokenized account numbers, while still preserving the condition-checking mechanism for tokenized account numbers when tokenized account numbers are used.

In this manner, configuring accounts to use tokenized account numbers and optionally to selectively prevent or allow transacting parties from using underlying account numbers to initiate transactions prevents either transacting party in a transaction from needing to expose their underlying account information, even when a resource handle (e.g., via a QR code, different account number, or payment address text) or tokenized account number is shared and even if underlying account information is otherwise compromised, promoting privacy and security for both parties.

In another embodiment, the institution may perform a lookup, e.g., to a directory service or other private database, to determine whether the address is a tokenized address or an actual address before determining whether to enforce additional conditions on the transaction in the event of a tokenized address. In one embodiment, the directory service is private to the fulfilling institution that processes the request, and the requesting institution and other institutions may have private directory services to manage tokenized account numbers specific to those institutions. This architecture allows the individual institutions to internally reference actual account numbers and externally reference tokenized account numbers and/or actual account numbers, optionally without revealing some actual account numbers to some external entities.

The directory service may additionally or alternatively be used to manage text-based resource handles that are not strictly numeric. If a user requests a resource handle that is already taken, the directory service may find and suggest similar resource handles that are not already taken from those available resource handles that are closest, in terms of characters or semantic chunks, to the requested resource handle. For example, the directory service may notify a user requesting “cardtrader@wellsfargo.com” that the requested resource handle is taken but that “traderofcards@wellsfargo.com” is available. In another example, the resource handle may conform to a hierarchy that allows similar resource handles to be used for different regions. For example, cardtrader@mx.wellsfargo.com may be available even though cardtrader@us.wellsfargo.com may be taken. Different resource handle hierarchies may be implied for different regions. For example, for transactions occurring in the U.S., the “us” prefix may be implied, and the “mx” prefix may be implied for transactions occurring in Mexico, even if the prefix is omitted from the transaction request.

In one embodiment, sub-identities may be established for individual accounts to support specific transactions. For example, an owner of the resource handle Jack. bankofamerica may set up a new resource handle for completing a transaction with a third party, such as the owner of Jill. staronecreditunion. In the example, the new resource handle may be Jack+Jill.bankofamerica or Jill.Jack.bankofamerica (with Jack owning the “.Jack.bankofamerica” suffix and any validation done for resource handles having that suffix and bankofamerica owning any “.bankofamerica” suffix and any validation done for resource handles having that suffix, in the example), or any other resource handle designated for the purpose of conducting the transaction, and the resource handle may be stored in association with rules that restrict transactions to certain types of transactions with Jill.staronecreditunion, in the example. For example, the transactions may further be time-limited or limited to certain amounts.

As a further example, both parties of the transaction may create unique resource handles for completing the transaction. Returning to the previous example, Jill may create a “Jill+Jack.staronecreditunion” resource handle or a “Jack.Jill.staronecreditunion” resource handle to engage in a transaction with Jack+Jill.bankofamerica or Jill.Jack.bankofamerica, and Jack's resource handle may be limited to transactions with Jill+Jack.staronecreditunion or Jack.Jill.staronecreditunion. In the example, the transaction-specific resource handle for a party may be derived from a resource handle of another party, and the transaction-specific resource handle of the other party may be derived from the party. Alternatively, the designated resource handles for a given transaction may be generated without any resemblance to the initial resource handle, based on random information or based on other information such as an invoice ID (e.g. “customtransactioninvoice123.bankofamerica” and “customtransactioninvoice123.staronecreditunion”). Either party to the transaction may use automated logic for generating accounts with certain naming conventions to support transactions with third parties as needs for such transactions arise (for example, in response to a shopping cart selection to transmit payment), or as a batch of accounts (tens, hundreds, or even thousands) that may be used for temporary transactional purposes. In these various examples, the parties to the transaction retain complete control over which entities may transact with which accounts, for how long, and to what extent.

In various embodiments, a set of candidate resource handles may be filtered based on a profanity filter or other filter to ensure that the resource handles are not being used for illegitimate purposes. For example, a blacklist of terms may be excluded from available resource handles, and the institution may have a reporting mechanism where existing handles that violate a terms of use may be reported if offensive, in which case the institution may disable the resource handle and suggest alternative resource handles that may be chosen to avoid the offensive terminology. As another example, a whitelist of acceptable terms may be included in a more closed system where only whitelisted terms and variations thereof (e.g., adding numbers before or after the whitelisted terms) may be selected for use as resource handles.

If an actual account number is being used, the lookup service may verify the actual account number is an existing account number. In one embodiment, the lookup service may return an actual underlying account number even if a tokenized account number is used, but may also return a set of conditions that must be satisfied in order to use the tokenized account number to complete the transaction. A transaction processor of the institution may consume the set of conditions and determine whether the currently requested transaction satisfies the set of conditions or not, and allow the current transaction to proceed only if the current transaction satisfies the set of conditions that were stored in association with the tokenized account number. In another embodiment, the lookup service returns the tokenized account number and the set of conditions, and only returns the actual account number upon a verification that the set of conditions are satisfied. In this manner, the de-tokenization of the tokenized account number to the actual account number may occur before or after the conditions have been verified to be satisfied, but the actual account number is used to complete the transaction only after the conditions have been verified to be satisfied.

In one example, a random number generator or pseudo-random number generator determines missing digits of a candidate tokenized account number and checks a registry with the institution to determine whether the candidate tokenized account number is already used or is available. If the candidate tokenized account number is already used, the random number generator or pseudo-random number generator may select a new number and re-check the registry with the new number. In another example, the institution maintains an array or queue of available or next available tokenized account numbers, and a user requesting a tokenized account number may receive a randomly selected or next available tokenized account number from the array. The underlying account number of the user may be stored in association with the newly selected tokenized account number so that the tokenized account number may be mapped back to the underlying account number in the event that the tokenized account number is used in a requested transaction.

Users who own accounts at the institution may configure any number of tokenized account numbers and/or resource handles to be used in association with a given account, such that transactions completed against the tokenized account numbers and/or resource handles when configured condition(s) are satisfied may be recorded to adjust balances of the underlying accounts managed by the institution and owned by the users. For example, a single account may be configured for use with multiple tokenized account numbers and/or resource handles, a first of which may be used for crediting resources above, below, or within a first threshold or range of amounts or at a specific amount for individual transactions or transactions with a same entity, group of entities, or sharing same characteristics; a first threshold remaining balance before or after the requested transaction occurs or would occur; from a first set of sources; to a first set of destinations; within a first time window or before or after a first time; after a first wait period during which a user may manually decide whether to approve or reject the transaction; and/or according to a first set of standing instructions; a second of which may be used for crediting resources above, below, or within a second threshold or range of amounts for individual transactions or transactions with a same entity, group of entities, or sharing same characteristics; a second threshold remaining balance before or after the requested transaction occurs or would occur; from a second set of sources; to a second set of destinations; within a first time window or before or after a first time; after a second wait period during which a user may manually decide whether to approve or reject the transaction; and/or according to a second set of standing instructions, and so on for many different tokenized account numbers with different uses all mapped to the same underlying account number.

In various embodiments, the tokenized account number may be mapped to an underlying account number via a mapping that is private to the institution managing the account number. In one example, the mapping may be determined via a smart contract once condition(s) associated with the account number are satisfied, and an underlying ledger may be managed as a blockchain of transactions associated with accounts. The smart contract may be generated based on user-selected conditions. For example, condition(s) indicating approved amount(s), approved target(s), source(s), time(s), or other transaction detail(s) may be stored in the smart contract as preconditions that must be satisfied before the account number may be resolved and transaction may be completed. A failure to satisfy the condition(s) may map, via the smart contract or another programmatic mapping, to a cancellation of the transaction, and/or a notification to any party involved (requester, requesting institution, fulfilling institution, and/or fulfilling account owner).

In another example, the mapping may be determined via a database stored privately by the fulfilling institution and not accessible to the requesting institution or the requester. The database may be managed by the fulfilling institution to ensure that requesters from other institutions or even from the same institution do not get access to the private account number unless the condition(s) stored in association with the tokenized account number are satisfied.

In one embodiment, the condition(s) may be implemented as code annotations to code requesting a transaction with the tokenized account number. The code annotations may include a first annotation to transactionally determine any conditions stored in association with the tokenized account number, second annotation(s) to evaluate whether the condition(s) are satisfied, and/or a third annotation to return the underlying account number after the prior determinations have been made only if the conditions are satisfied. In this manner, the logic for determining the mapping between the account number from the tokenized account number may be called or executed only after the condition(s) have been satisfied, without regard to other code that is executed after the account number has been resolved. If the condition(s) are not satisfied, an error or other information may be returned by the code-implemented pre-conditions, causing the transaction to be canceled.

In one embodiment, the mapping may be determined using an encryption key or mechanism that is accessible via a wrapper on tokenized account numbers only after verifying that the condition(s) are satisfied. The encryption key or mechanism may be used to convert data stored in association with the tokenized account number into an actual account number for completing the transaction.

In various embodiments, one or multiple resource handles may be allocated for a single tokenized account number, and one or multiple tokenized account numbers may be allocated for a single underlying account. If condition(s) are configured in association with a tokenized account, the condition(s) may be enforced across any or all resource handles that use the tokenized account number. If condition(s) are configured for an underlying account, the condition(s) may be enforced across any or all resource handles that use the underlying account and/or any or all resource handles that use any or all tokenized account numbers mapped to the underlying account. In this manner, a user may configure conditions for certain purposes in association with tokenized accounts and re-use that configuration for different resource handles rather than configuring each resource handle separately.

Configurations may be specified in a user interface by a user authenticated into the user's account with the user's institution. Additionally or alternatively, configurations may be specified in response to push notifications about transactions for which conditions have not yet been specified, where a user may respond to the push notifications to set up conditions for automatic approval or rejection going forward to override manual approval or rejection of transactions. Additionally or alternatively, configurations may be learned based on user activity. If a user historically allows transactions of a certain type or matching certain conditions, a notification may be sent to the user to suggest the matching conditions be added to automatically approve or reject transactions satisfying the conditions.

In one embodiment, condition(s) stored in association with the tokenized account number and/or a resource handle used to reference the tokenized account number or actual account number may be based on an identity or metadata stored in association with the requesting entity. For example, the tokenized account number and/or resource handle associated with that tokenized account number may be useable only to send and/or receive resources from certain sources or targets. In another example, the tokenized account number and/or resource handle may be useable only to send and/or receive resources from sources or targets satisfying certain criteria or within certain groups. In a particular example, the sources and/or targets may be tracked by the institution to determine a legitimacy score that measures legitimacy in making transactions, based on past transactions that were successful, unsuccessful, and/or flagged as fraudulent or otherwise objected to by another requesting or fulfilling entity. The condition(s) may be based on the legitimacy score of the requesting entity to protect the fulfilling entity from receiving or committing funds to an entity that has been frequently or otherwise historically involved in illegitimate or objectionable transactions.

In one embodiment, a requesting entity using a resource handle and/or tokenized account number may cache information about the resource handle and/or tokenized account number for use in another transaction, to avoid a future roundtrip with a directory service. For example, the requesting entity may determine in a first request that the resource handle is mapped to a tokenized account number and cache the tokenized account number for future use in association with the resource handle. In another request directing resources to or from the resource handle, the requesting entity may instead direct resources to or from the tokenized account number, avoiding a round trip with the directory service to look up which tokenized account number is associated with the resource handle. The fulfilling institution may then internally map the tokenized account number to the underlying account number to fulfill the request and externally report back a transaction against the tokenized account number.

In a particular embodiment, a directory service may provide a mapping between resource handles and account numbers, resource handles and tokenized account numbers, and/or tokenized account numbers and account numbers with an expiration date or time. For example, the provided mapping may be provided with metadata indicating that the mapping is active and may be cached for up to 5 hours, 3 minutes, or 4 days, or any other amount of time before such mapping becomes stale and needs to be reconfirmed with the directory service. The directory service may keep track of when mappings were last requested and amounts of time indicated for the mappings to be cached and use this information to determine when to make a change to a new mapping. A directory service approaching a change may reduce a cache time provided to the requesting entity, to avoid having the requesting entity use a stale mapping. Even if the requesting entity has cached a mapping, a future transaction using the correct mapping may still be rejected based on changing conditions or configurations of the underlying account, tokenized account, and/or resource handle, which may be performed at any time by the account owner.

In one embodiment, a directory service may provide a shared secret as part of a caching mechanism to ensure that a re-used mapping is still being used to refer to the same fulfilling entity. For example, a cached resource handle may be re-assigned in between uses, and the requesting entity may provide additional metadata that was received when the resource handle was initially cached to validate that the cached mapping is being used to refer to the correct entity. For example, the additional metadata may include information about the account owner, or may be randomly generated information stored in association with the mapping, as long as the information is provided by the requesting entity with the re-used mapping and known to fulfilling entity so that the request may be validated as using the handle or tokenized account number to refer to the correct entity (e.g., an entity having the same details or otherwise associated with the same shared secret).

In various embodiments, a requesting entity may receive different information from the fulfilling entity depending on a type of the requesting entity. For example, if the requesting entity is an individual, the fulfilling entity may limit the amount of information provided about the account owner to a subset of information or no information at all. If the requesting entity is a financial institution, a governmental entity, or an entity of a trusted type, the fulfilling entity may provide an amount of information about the account owner based on a level of trust stored in association with the entity.

### Financial Institution Registration

In various embodiments, a resource identity directory service provides an interface for financial institutions to sign up to manage resource handles for members of the financial institution. The resource handles may be managed by the financial institution, but the suffix, namespace, or another identifying part of the resource handles refers to the financial institution that is registered to manage resource handles. Upon registration, the suffix, namespace, or other identifying part of resource handles that will be used to refer to the financial institution is stored in the directory to route resource transfer requests associated with that suffix, namespace, or other identifying part to the registered financial institution. Different financial institutions have different suffixes, namespaces, or other identifying parts of resource handles, and may overlap in prefixes since those prefixes would refer to different members of the different financial institutions.

In one embodiment, a financial institution may register multiple suffixes, namespaces, or other identifying parts of resource handles that each refer to the financial institution. The financial institution may manage the different suffixes, namespaces, or other identifying parts to use for different subsets of account holders, such as account holders in different regions or account holders belonging to different branches or franchises under the same financial institution umbrella.

Resource handles using a hierarchical namespace may scale like a domain name space (DNS) directory, with account owner group prefix namespaces being added to bank, bank division, and/or region suffixes. Further subdivision of banks or regions may be accomplished by adding further suffixes to the namespace, with transactions occurring within a given region or bank or bank division not needing to use the additional suffixes to complete the transaction and transactions occurring outside the given region or bank or bank division adding the suffixes to complete the transaction with respect to the correct account in the correct region at the correct bank division.

In various embodiments, the directory service may store hierarchical information about member financial institutions, such as storing financial institutions in a same region or country separately such that suffixes, namespaces, or other identifying parts may be re-used across different regions as long as the region is also identified explicitly in the resource handle or implicitly based on where the resource handle is being used. In various other embodiments, the directory service stores financial institution suffixes, namespaces, or other identifying information at a same flat level such that the suffix, namespace, or other identifying information is globally unique.

The financial institution may create default resource handles for account holders of the financial institution, with default permissions, or may allow account holders to opt in to resource handle(s) with default or custom permissions via a registration interface that is managed by the financial institution. The individual resource handles of members of the financial institution and the accounts mapped to those resource handles may be opaque to the resource identity directory service and opaque to other financial institutions. In other words, the financial institution is the source of truth for the existence, validity, permissions, and underlying account mappings of resource handles having the suffix or other identifying part corresponding to the financial institution.

In one embodiment, an existing resource identity directory service, such as Zelle® may be identified as a financial institution in a global resource identity directory service. The global resource identity directory service may identify the existing resource identity directory service with a registered suffix of resource handles, such that what was once a global identifier (email or phone number, for example) independent of financial institutions on the existing resource identity directory service is now an identifier specific to the existing resource identity directory service. For example, the phone number, 555-555-5555, may have once identified an individual for payment on the existing resource identity directory service but is now used to automatically generate a resource handle 5555555555@zelle, which can be used as a resource handle in a system that also honors resource handles exchanged on behalf of other financial institutions, such as Bank of America or U.S. Bank, optionally using the same phone number to separately refer to an account at the corresponding financial institution. In other words, a transaction initiated to a resource handle associated with the existing resource identity directory service is routed to the existing resource identity directory service using the resource handle, and another transaction initiated to another resource handle associated with a traditional financial institution is routed to the financial institution using the other resource handle.

### Example Interface for Initiating Resource Transfers

The transaction initiating financial institution may provide an application that runs on client devices belonging to account holders. The application provides a user interface for authenticating the user to the initiating financial institution and displaying an option to initiate a transaction between one of the user's accounts and a resource handle without specifying a target account number for the resource handle. The application initiates a transaction for the resource handle by communicating with a resource identity directory service to verify the validity of the resource handle and identify the financial institution associated with the resource handle, and communicating with the financial institution associated with the resource handle to complete the transaction without revealing the target account number or even a tokenized version of the target account number to the user.

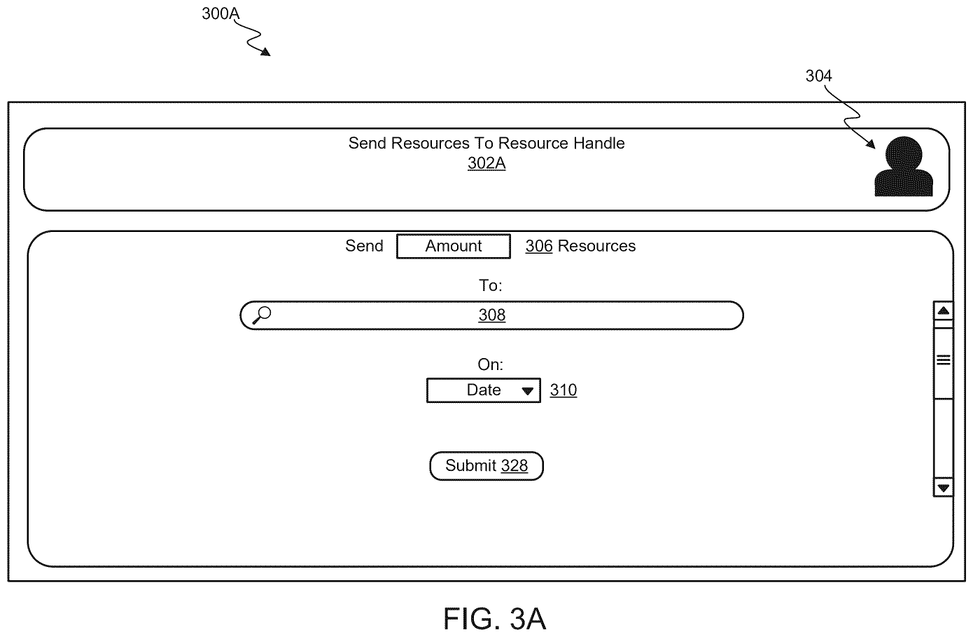

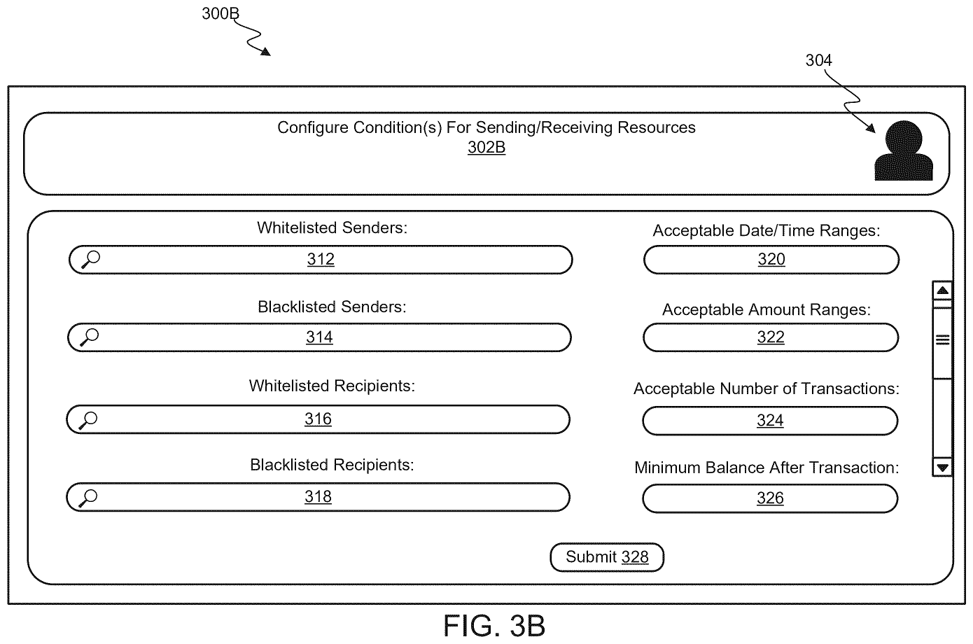

FIG. 3A illustrates a diagram of an example user interface 300A showing initiating a resource transfer using a specified resource handle. As indicated by header 302A, user interface 300A allows authenticated user 304 to send resources to another resource handle. Option 306 allows authenticated user 304 to select an amount of resources to send to a target resource handle, and option 308 allows authenticated user 304 to select the target resource handle for sending the amount of resources. Option 310 allows authenticated user 304 to select a date and/or a time on which to trigger the resource transfer. Submit option 328 causes a system managing an account for authenticated user 304 to initiate the requested resource transfer and/or to place the requested resource transfer in a queue to be initiated at the selected date and/or time on which the resource transfer is to be triggered.

In one embodiment, a unified payments interface (UPI) is provided or embedded in an application and allows multiple accounts to be managed in a single mobile application such that a user of the multiple accounts can initiate transactions between any of the user's accounts and resource handles of other accounts.

In a particular embodiment, an identity service with permissions is implemented in an application. The identity service authenticates a user to one or more accounts associated with one or more resource handles, and the permissions are configurable and stored in association with the corresponding resource handles. The identity service may allow the user to update permissions and initiate or complete transfers within the conditions specified by the permissions. The identity service may be modular and compatible with multiple banking applications such that the functionality can be added to existing banking application, exposing functionality via a common API used by multiple financial institutions to initiate transactions between the account holder and other account holders based on their resource handles.

### Example Payment Interface

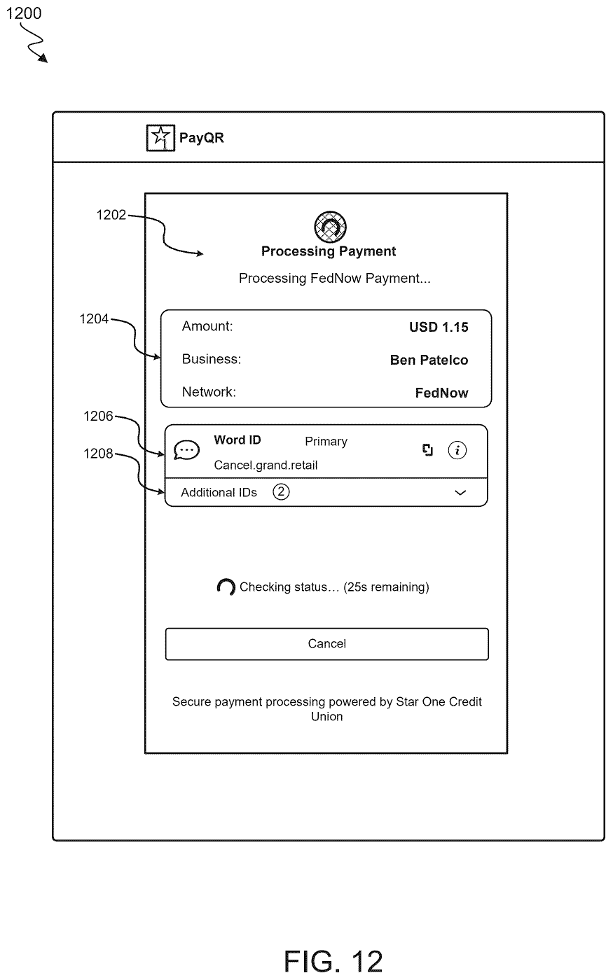

Selection of a “Pay” option 1112 on the example interface of FIG. 11 may result in a payment process interface 1200 of FIG. 12 causing display of a payment processing status 1202 and optionally metadata 1204 about the transaction. The payment process interface may also show a Word ID or other tuples 1206 determined from the transaction information or independently in support of the transaction. As shown, the Word ID includes tuples of words connected with a delimeter (“.”, in this case), which may be verified by a reviewing party who may have been notified before initiating the transaction that the Word ID should be expected as “cancel.grand.retail.” Additional IDs 1208 such as a Transaction ID (“TXN-MD6CCHBEHME01R”, for example) and a Payment Hub ID (“202507163211779682329778870065048”, for example) may also be shown under the “Additional IDs” tab. In some embodiments, the Word ID may be independently derived at random or derived from one or more of the other IDs as a more easily verifiable ID than a seemingly random string of characters of the other IDs.

Selection of the “Pay” option 1112 to pay a third party may also cause a verification service supporting the interface of FIG. 11 to communicate encrypted information associated with the user selecting the “Pay” option 1112 to the third party for mutual verification that the user is authorized to initiate the transaction to based on the secure payment request of FIG. 11. The third party may analyze the Pay request for a specific certificate, credentials, timing, resource handle information, and/or other transaction criteria to determine whether to proceed with triggering the transaction using the “Pay” option 1112 from FIG. 11.

Selection of the “Pay” option 1112 may trigger activity at a speed and priority depending on a selected payment speed option 1108 from among candidate payment speed options. In the example, “Instant Payment” may be selected to receive the payment within seconds, but a lower priority and slower route may also be taken to allow financial institutions to prioritize processing of time-sensitive transactions over less time-sensitive transactions. Selection of the “Cancel” option 1110 from FIG. 11 cancels the transaction without using the secure payment request 1104. A canceled transaction may be deleted or saved for later evaluation prior to completion or deletion.

### Example Interface for Managing Resource Handle Permissions

FIG. 3B illustrates a diagram of an example user interface 300B showing configuration of condition(s) for sending and/or receiving resources. As indicated by header 302B, user interface 300B allows authenticated user 304 to configure condition(s) for sending and/or receiving resources. Options 312 and 316 allow authenticated user 304 to select whitelisted sender(s) or recipient(s), respectively, for which to allow resource transfers. Options 314 and 318 allow authenticated user 304 to select blacklisted sender(s) or recipient(s), respectively, for which to disallow resource transfers. Option 320 allows acceptable date/time ranges to be specified during which resource transfers are allowed and outside of which resource transfers are disallowed. Option 322 allows acceptable amount ranges to be specified within which resource transfers are allowed and beyond which resource transfers are disallowed. Option 324 allows an acceptable number of transactions to be specified within which resource transfers are allowed and beyond which resource transfers are disallowed. Option 326 allows minimum balances after transactions to be specified within which resource transfers are allowed and beyond which resource transfers are disallowed. Submit option 328 causes a system managing an account for authenticated user 304 to save the condition(s) indicated by option(s) 312, 314, 316, 318, 320, 322, 324, and/or 326 and apply the saved condition(s) to a specific resource handle for authenticated user 304, which may be selectable on user interface 300B or an interface visited by user 304 prior to navigating to user interface 300B.

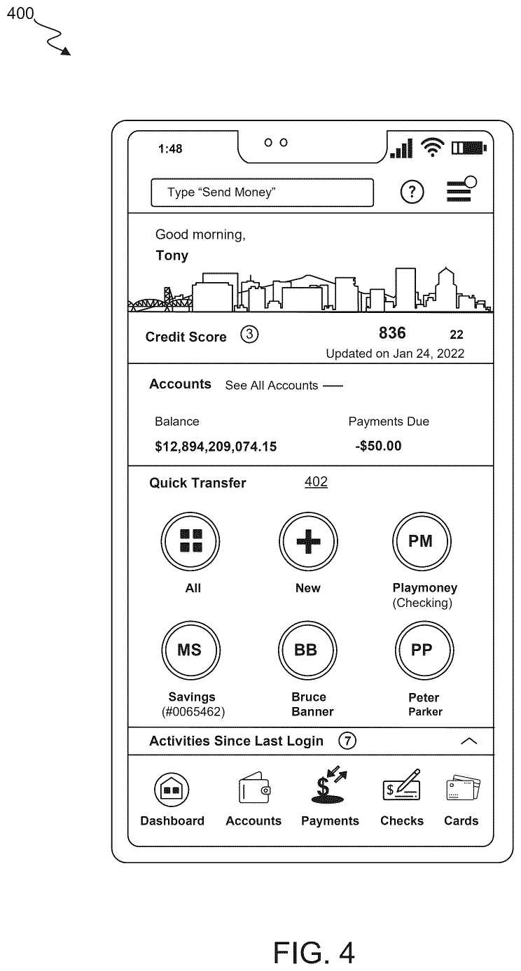

FIG. 4 illustrates an example user interface 400 for initiating a resource transfer from a mobile device. As shown, quick transfer region 402 allows an authenticated user to select from among a plurality of resource handles and/or specific account numbers for which to initiate resource transfers. Upon selecting a specific account number, the resource transfer may be completed without consulting a resource identity directory service and by directly recording the transfer with the target account number. Upon selecting a resource handle, the process 100 of FIG. 1 may be triggered.

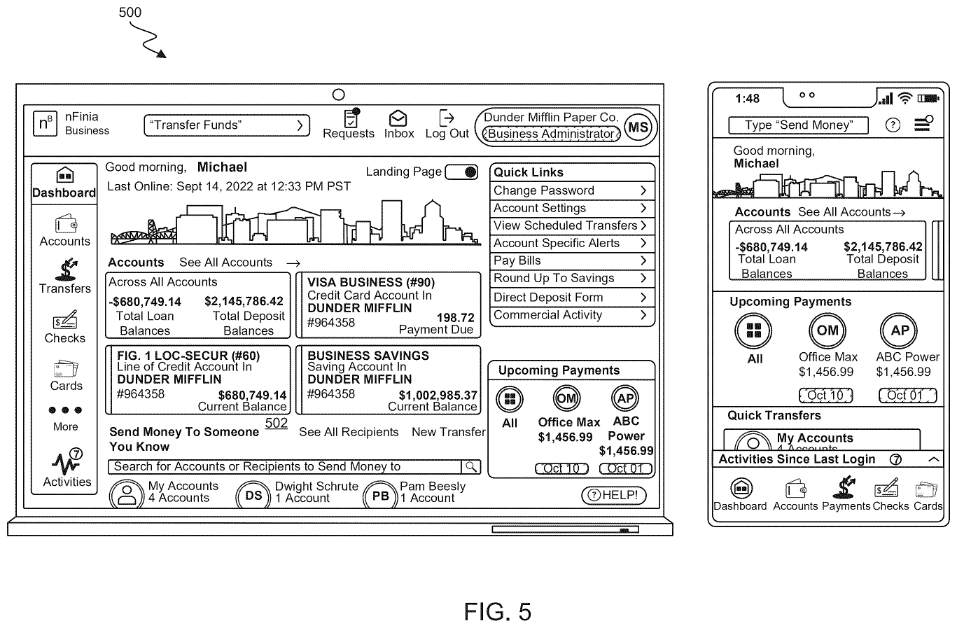

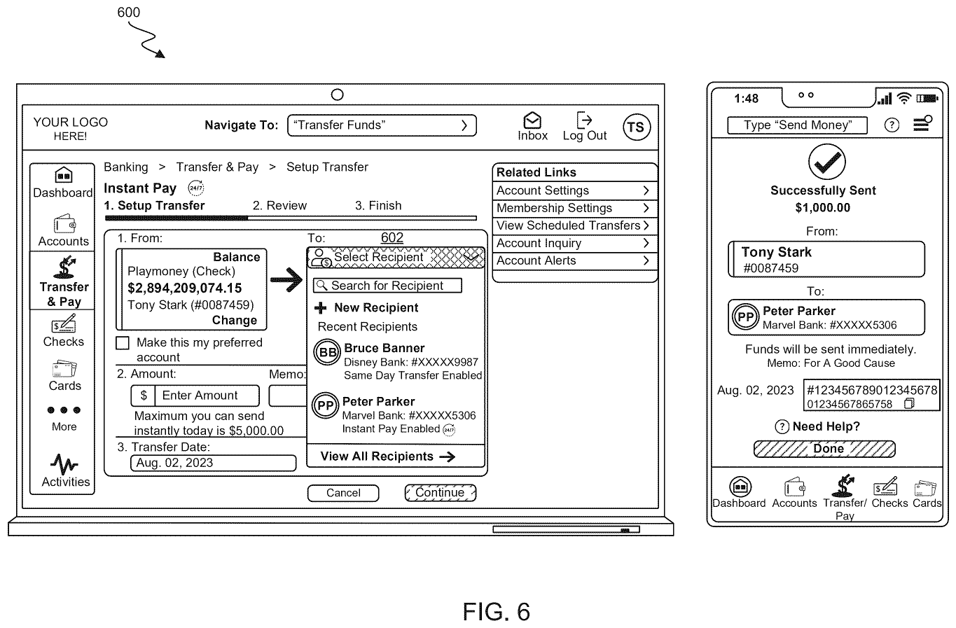

FIGS. 5 and 6 illustrate example user interfaces for initiating resource transfers from a laptop and/or a mobile device. As shown in FIG. 5, the send to someone you know region 502 allows an authenticated user to select from among a plurality of resource handles and/or specific account numbers for which to initiate resource transfers, and/or to create a new transfer with a new account number and/or resource handle. Upon selecting a specific account number, the resource transfer may be completed without consulting a resource identity directory service and by directly recording the transfer with the target account number. Upon selecting a resource handle, the process 100 of FIG. 1 may be triggered.

As shown in FIG. 6, the select recipient field 602 allows an authenticated user to select from among a plurality of resource handles and/or specific account numbers for which to initiate resource transfers, and/or to create a new recipient with a not yet specified account number and/or resource handle. Upon selecting a specific account number, the resource transfer may be completed without consulting a resource identity directory service and by directly recording the transfer with the target account number. Upon selecting a resource handle, the process 100 of FIG. 1 may be triggered.

As shown in FIGS. 4-6, account number(s) and/or resource handles of resource transfer targets may be saved by the transaction-initiating entity and recalled on user interfaces 400, 500, and 600 when another resource transfer is initiated with the same resource transfer target. In this scenario, the resource transfer may be completed without consulting a resource identity directory service if a resource management entity for the resource handle has been saved by the transaction-initiating entity. The transaction-initiating entity may also save and cause display of reputation scores associated with each of the saved resource transfer targets, and the reputation scores may be periodically updated.

In one embodiment, the account holder has one or more resource accounts, each account with zero or more corresponding resource handles configured for resource transfer access to the resource account. The account holder may be an entity such as a company, and the account holder may have a higher-level entity account that includes the one or more resource accounts. The entity account may have one or more users each with corresponding access controls to resource accounts in the entity account. One or more of the users of the entity account may be configured with administrative access controls to configure access of other users for the entity account, and different users may have different levels or types of access to different information about same or different resource handles, about same or different resource accounts, and/or about same or different types of transactions posted to the resource handles or resource accounts. An access configuration user interface may provide options to one or more of the users to configure access of other users, and the users may have read access, the ability to post transactions themselves, the ability to reverse transactions, the ability to run reports or analytics on posted transactions or aggregate data of posted transactions.

Different users for an entity may have different levels of authority to authorize transfers out of an account for the entity. For example, a user profile for the user may store a resource handle access privilege or a resource account access privilege that indicates the user is authorized to transfer a limited amount of resource to or from the account, or authorized to coordinate the transfer of a limited amount of resources to or from the account via transfers directly approved by the user or transfers approved automatically by rules configured by the user. In this manner, the entity retains specific, hierarchical, layered controls of the resource accounts that can be associated with corresponding resource handles and used to transfer controlled amounts of resources to or from the resource account.

In one embodiment, the resource handle is created for a trading account with an authorization or approval required for approving transactions on the resource handle. The authorization or approval may be configured by a user or users who have requested to be included in an authorization or approval pipeline for the resource handle. In one embodiment, an administrative user may configure which users are allowed to add themselves as required approvers in approval pipelines and which users are not allowed to add themselves as required approvers in approval pipelines, and for which resource handles and which resource accounts.

In one embodiment, the resource handle represents accounts that have delegates and/or powers of attorney that approve or authorize transactions. An administrative user for the entity may configure which users have delegate and/or power of attorney authority for which resource handles and/or which resource accounts. The users with delegate and/or power of attorney authority for the resource handle and/or resource account may have access to the access configuration user interface for configuring access of other users with respect to that resource handle and/or resource account but optionally not with respect to other resource handles or resource accounts managed by the same entity.

In one embodiment, a resource handle configuration interface allows configuration of resource handle permissions and other settings. In one example, the resource handle configuration interface provides an option to select which users are required approvers, if any, for push transfers using the resource handle, pull transfers using the resource handle, or other actions with respect to the resource handle. The resource handle configuration interface may provide an option to specify that the resource handle requires approvers or not. In one embodiment, the resource handle configuration interface provides options for configuring approvals and non-repudiation of transaction approvals. The options, if selected, may configure a mechanism by which transactions are approved and whether the transactions can be repudiated or not. The options may also allow configuration of smart contracts that are allowed or required to be executed in transactional combination with corresponding resource transfers for the corresponding resource handle.

### Resource Handle Reputation-as-a-Service

In some embodiments, a financial institution may allow members of the financial institution to sign up for sharing their resource transaction reputation with other financial institutions and other members of other financial institutions. The resource transaction reputation may be tied to the resource handles rather than to the individual account numbers, such that sharing the reputation information does not expose account numbers for potential malicious or fraudulent activity. The reputation information may track a number of transactions completed for the resource handle, such as transactions transferring resources to the resource handle and/or transactions transferring resources from the resource handle, and/or may track an amount of resources transferred to the resource handle and/or from the resource handle, and/or a time the resource handle has remained in active use. The reputation information may additionally or alternatively include information about reviews provided by other members of the same or different financial institutions, such as whether the entity associated with the resource handle held up another end of a deal that involved the transfer of resources to or from the resource handle. Such information may be useful to determine whether the resource handle is frequently engaged in honest dealings or not, and businesses may be incentivized to share a reputation of their resource handle with other members to put the other members at ease that the businesses are engaged in honest dealings.

In order to ensure that the reputation system is not populated with unrepresented or false information, each transaction with the resource handle may have an option to rate the transaction and feed into an overall reputation score of the resource handle. The overall reputation score may normalize feedback per rating party, per unit of resource (e.g., per dollar spent), or per transaction, and share a reputation score normalized in any such manner for display on an interface when dealing with the underlying businesses. The reputation score may also indicate how many unique rating parties or transactions have contributed to the score, regardless of how the score is normalized.

The transaction initiating financial institution may cause display of received reputation scores associated with specific resource handles of same or other financial institutions, and may exchange reputation scores of resource handles with other financial institutions periodically to keep the reputation scores up-to-date. Alternatively, the financial institutions may subscribe to reputation score updates, which get pushed from the subscribed-to financial institution to other financial institutions as the reputation scores get updated, or in batches.

### Fraud Detection

In various embodiments, potentially fraudulent activity may be detected based on activity associated with the resource handles. Because the resource handles are not as confidential as account numbers, reputation scores of the resource handles may be shared between financial institutions, and financial institutions may use the reputation scores to detect potentially fraudulent activity associated with a particular resource handle. If fraud is detected in relation to a resource handle, the resource handle may be disabled without requesting permission from an account owner of the account corresponding to the resource handle.

In one embodiment, configuring accounts to use secure resource handles and optionally to selectively prevent or allow transacting parties from using underlying account numbers to initiate transactions prevents either transacting party in a transaction from needing to expose their underlying account information, even when the resource handle (e.g., via a QR code, different account number, or payment address text) is shared and even if underlying account information is otherwise compromised, promoting privacy and security for both parties. If a party attempts to use a mode of transactions that is unauthorized for the account, such as a transaction using the raw account number instead of a resource handle for an account configured to allow transactions only through the resource handle, such attempts may be traced to the source for fraud detection purposes. This tracing may immediately identify which account information is being used to attempt the fraudulent or mistaken transaction such that preventative, corrective, and/or legal actions may be taken. Additionally, the account holder may be notified that such an attempt has been made that is outside the bounds of the configured resource handle and account.

### Merchant Registration

In one embodiment, a financial institution or service provider provides an interface for a merchant to enroll in a process for exchanging resources with customers or potential customers via resource handles. The merchants may request merchant-specific resource handles from the financial institution or service provider, and the financial institution or service provider may check to ensure that the resource handle is unique. In one embodiment, the financial institution or service provider also provides a service to check that the selected merchant resource handle is not close (e.g., within a character or two) to resource handles selected by other account holders of the financial institution or service provider. In one embodiment, the financial institution may interact with other financial institutions to ensure the selected resource handle is unique and not close to resource handles by selected other financial institutions or service providers as well as the financial institution or service provider of the merchant.

The merchant may set up the merchant-specific resource handles to receive resources from users and route the resources to an account. In one embodiment, resource transfers using a merchant-specific resource handle or other resource handle may include a merchant transaction identifier that is shared from the merchant to the customer to match the transaction to a specific paying customer. For example, the merchant transaction identifier may be stored as metadata to a requested resource transfer, and the metadata is passed to the financial institution or service provider with the resource transfer request and saved in a ledger associated with the underlying account of the merchant. The merchant transaction identifier may be a merchant invoice identifier, an order identifier, or a receipt number, for example. The merchant may use the merchant transaction identifier in a financial institution or service provider application to track invoices that have been paid and invoices that have not yet been paid, and the invoices may automatically be stored in association with revenue or expense codes that are pulled from metadata stored by the merchant in association with the invoice. In one embodiment, the receipts and debits are automatically consumed by an expense and revenue management application and automatically incorporated into a running balance sheet for the merchant. For example, the receipts and debits may be added to Quickbooks® along with the relevant codes that are used in Quickbooks® to classify the expenses.

In one embodiment, merchants may set up alerts and reminders for merchant transaction identifiers that are not yet associated with a completed resource transfer request. Such reminders may be used to remind the merchant and/or send a notification to the customer based on customer metadata stored in association with a customer profile on the financial institution or service provider application. For example, the customer profile may include an email address that is emailed after the invoice has been active for over a day and is not yet matched to a resource transfer request.

### Consumer-to-Merchant Transactions

In one embodiment, a consumer may use the merchant-specific resource handle to initiate a resource transfer with the merchant. For example, a consumer purchasing goods or services from the merchant may use the resource handle to transfer payment to the merchant for the goods or services. The consumer may initiate the payment via a resource handle plug-in or applet to an application offered by the consumer's financial institution or service provider. For example, the consumer may initiate a payment to the resource handle by entering the resource handle into the plug-in or applet within the financial institution's application installed on the consumer's mobile device. In another example, plug-in or applet of the application on the consumer's mobile device may provide an option for the consumer to use the mobile device's camera to scan a QR code or other scannable information that identifies the resource handle and/or the amount to be paid. For example, the QR code or other scannable information may specify a JSON object or other structured object that includes the resource handle of the merchant in one portion of the structured object and an amount of the requested transfer in another portion of the structured object. The consumer may see a pre-populated indication of the resource handle and the amount of the requested resource transfer before requesting, in the consumer's financial institution's application, to initiate the transfer.

In one embodiment, a merchant device generates the QR code or other scannable information that specifies a structured object such as a JSON object including delimited portions that specify the merchant's resource handle, the amount of a particular transaction, and/or metadata that indicates a merchant transaction identifier for matching to the particular transaction when the resource transfer request is submitted with the metadata. The QR code or other scannable information may be configurable to be consumed by various financial institution plug-ins or applets to financial institution applications for initiating resource transfers using resource handles. For example, the plug-ins or applets may be commonly distributed portions of financial institution applications that are consumable to convert standard financial institution applications into applications that are capable of initiating resource transfers with resource handles.

In various embodiments, the merchant can set accepted payment methods, transaction limits, and real-time payment notifications for payments being processed with the merchant transaction identifier. For example, the merchant may interact with the merchant's financial institution application or service provider to set transaction limits for transactions to be performed using the merchant's resource handle or a subset of the merchant's resource handles, or to configure same or different payment notifications or reminders with respect to different resource handles. The payment notifications or reminders may be mapped to different merchant-side parties (e.g., using different phone numbers or email addresses) for different resource handles even if the resource handles are mapped to the same merchant account.

The merchant account may be tracked based on which resource handles were used to add or remove resources from the account at what times. Different resource handles may be used to add or remove funds, and the additions or removals may be grouped by resource handles with aggregate amounts shown for different periods.

### Using Resource Handles in Commerce

In one embodiment, the resource handles may be used to support recurring billing for subscription services, installment payments, and integration with loyalty programs, such that the resource handles of a merchant or other user are authorized to send or receive resources under certain conditions or circumstances. For example, a resource handle used for a subscription service may be authorized to deduct an amount within a specified range or with an exact value periodically within a specified period. The conditions may be stored among the stored conditions associated with the resource handle. As another example, a merchant resource handle may be authorized to deduct an amount from a merchant's account upon confirmation from a loyalty server that a certain amount may be deducted. The loyalty deduction may be limited to a certain range of amounts to guard against unintended transfers due to unexpected behavior from the loyalty server.

In one embodiment, a resource handle is approved for certain types of resource transfers, such as purchases, refunds, and/or pre-authorizations. The resource handle may distinguish between the different types of transactions based on metadata received with the resource transfer request, and/or by matching a merchant transaction identifier with a type of transaction involved. For example, the financial institution or service provider application may have stored conditions that are integrated with a merchant database such that the conditions make a call-out to the database with a specific merchant transaction identifier to determine if certain characteristics of the merchant transaction identifier satisfy the one or more conditions otherwise managed by the financial institution or service provider application.

### System Architecture

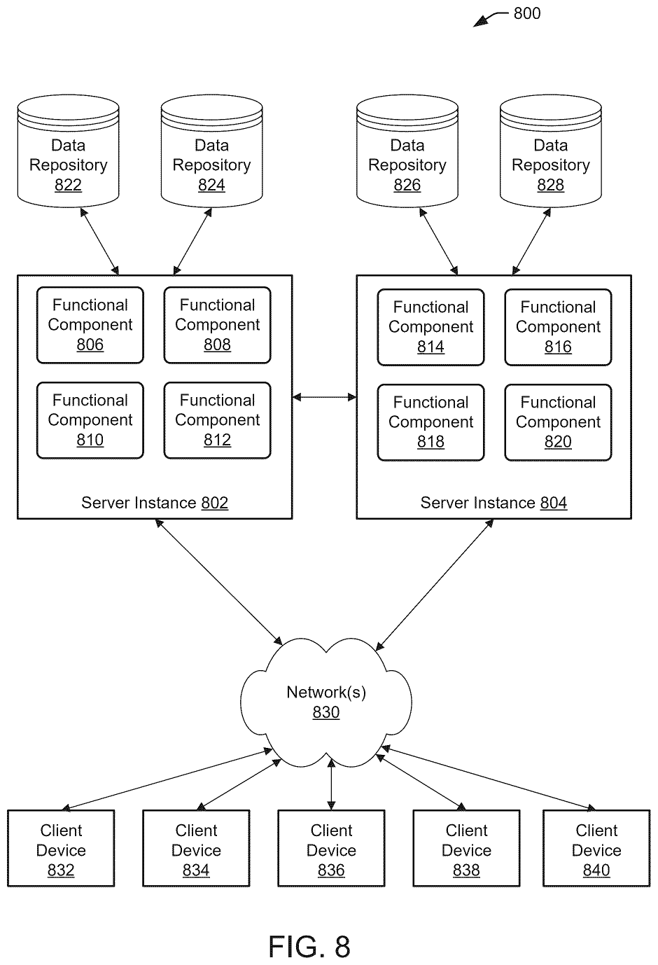

FIG. 8 illustrates a diagram of a distributed system 800 for managing a resource transfer based on one or more conditions stored in association with a resource handle involved in the resource transfer. FIG. 8 shows client computing devices 832, 834, 836, 838, and 840 in communication with server instances 802 and/or 804 via one or more networks 830. Users may use the client computing devices to access services offered by the server instances 802 and/or 804. The client computing devices may include smart phones or other portable handheld devices, general purpose computers such as personal computers and laptops, workstation computers, personal assistant devices, wearable devices, equipment firmware, gaming systems, and the like.

Each server instance 802 and 804 include functional components 806, 808, 810, 812, and 814, 816, 818, and 820, respectively. The functional components are configured to perform functions to carry out the services offered by the corresponding server instance 802 or 804. For example, one server instance may provide services for initiating a transaction, and another server instance may provide services for checking stored condition(s) in association with a target user handle to determine whether the transaction is approved to proceed to completion or not.

Server instances 802 and 804 may store and access data in data repositories 822, 824, and 826, and 828, respectively. Data repositories 822 and/or 824 may be private from server instance 804, protected via a firewall and data encryption and accessible only by an authenticated user associated with an owner of server instance 802. Data repositories 826 and/or 828 may be private from server instance 802, protected by a firewall and data encryption and accessible only by an authenticated user associated with an owner of server instance 804.

The client and server devices may use various operating systems, such as any of Microsoft Windows®, Apple MacOS®, UNIX® or UNIX-like operating systems, Linux® or Linux-like operating systems, Android®, and Apple iOS®, which provide software access to underlying hardware resources.

The data stored in data repositories 822, 824, 826, and/or 828 may include instructions and data or other stored objects on which the instructions operate. The stored data may also include data about account numbers and corresponding balances, transactions posted to accounts, resource handles managed by the owner of the corresponding server instance, and condition(s) stored in association with resource handles for determining when the resource handle is usable to transfer resources.

Server instance(s) 802 and/or 804 may run on a computer system comprising one or more data processors that access non-transitory computer-readable storage media such as data repositories 822, 824, 826, and/or 828. For example, the computer system may access stored instructions which, when executed on the one or more data processors, cause the one or more data processors to perform part or all of one or more methods disclosed herein. One or more of data repositories 822, 824, 826, and/or 828 may be removably attached as one or more computer-program products. The computer-program products store instructions and include a non-transitory machine-readable storage medium that stores instructions configured to cause one or more data processors to perform part or all of one or more methods disclosed herein.

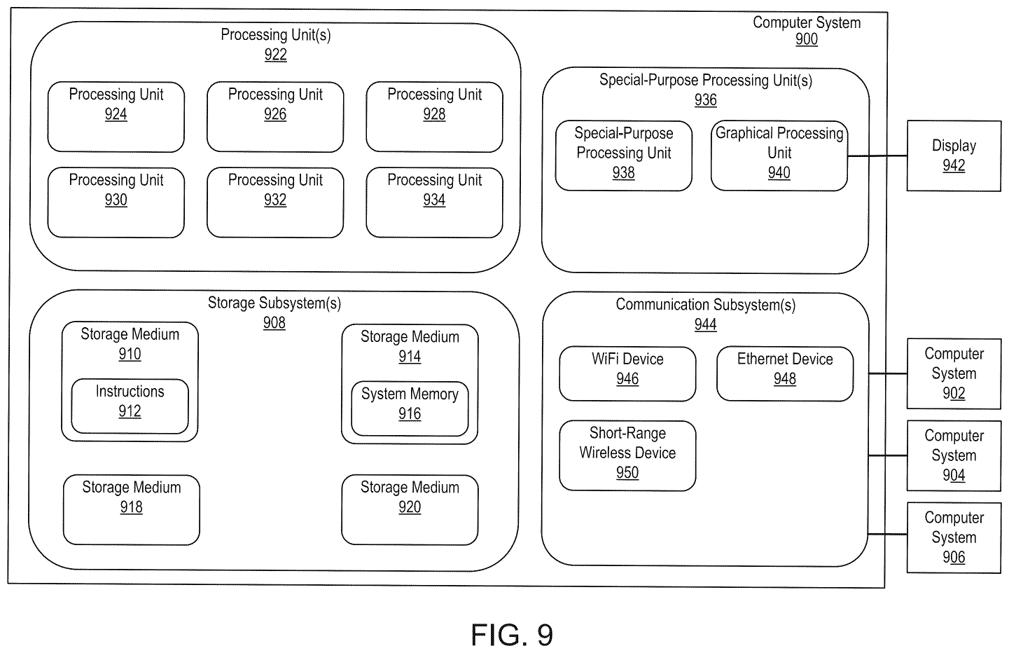

FIG. 9 illustrates an example computer system 900 that may be used to implement certain aspects. As shown in FIG. 9, computer system 900 includes various subsystems including a processing subsystem of processing unit(s) 922 and special-purpose processing unit(s) 936, a storage subsystem 908, and a communications subsystem 944. Storage subsystem 908 may include non-transitory computer-readable storage media including system memory, stored instructions, and other storage media. Computer system may also include input devices such as mice, keyboards, touchscreens, touchpads, buttons, joysticks, and output devices such as a display 942 and speaker.

Storage subsystem may include one or more non-transitory memory devices, including volatile and non-volatile memory devices. As shown, storage subsystem 908 includes a system memory and other computer-readable storage media. System memory may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system, such as during start-up, may typically be stored in the ROM. The RAM may contain data and/or program modules in the process of being operated and executed by processing subsystem. In some implementations, system memory may include multiple different types of memory, such as static random access memory (SRAM), dynamic random access memory (DRAM), and the like.

Computer-readable media may store computer-readable instructions, data structures, program modules, and other data for computer system to operate. Software (programs, code modules, instructions) that, when executed by processing subsystem provides the functionality described above, may be stored in storage subsystem. By way of example, computer-readable storage media may include non-volatile memory such as a hard disk drive, a magnetic disk drive, an optical disk drive such as a CD ROM, digital video disc (DVD), a Blu-Ray® disk, or other optical media, flash memory cards, universal serial bus (USB) flash drives, secure digital (SD) cards. Computer-readable media may also include solid-state drives (SSD) based on volatile or non-volatile memory.

Communication subsystem 944 may support both wired (e.g., Ethernet) and/or wireless communication protocols (e.g., WiFi, Bluetooth, etc.), for example, via Ethernet device 948 and WiFi device 946 and/or short-range wireless device 950.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
receiving a request to perform a resource transfer between a first account and a second account, wherein the request originates from a requesting entity and identifies:
first information sufficient to initiate a transaction with the first account,
a second resource handle for the second account without specifying an identity of the second account, and
a requested amount of a resource to be transferred to or from the second account;
wherein the request is routed to a management entity for the second account based at least in part on a second namespace of the second resource handle;
processing the request by the management entity for the second account at least in part by identifying, by the management entity, the second account mapped to the second resource handle based at least in part on a mapping stored privately by the management entity and not shared with or accessible to the requesting entity;
accessing one or more stored conditions specified for and stored in association with the second resource handle; wherein the one or more stored conditions are based on one or more characteristics other than the identity of the first account, and wherein the one or more characteristics are required to have one or more values that must be satisfied in order to approve the resource transfer;
based at least in part on determining the one or more stored conditions are satisfied:
storing, in association with the second account, information to indicate the resource transfer is in process;
transmitting, to the requesting entity, a particular identifier for the second account, wherein the particular identifier is valid for completing the resource transfer between the first account and the second account;
receiving an indication that the resource transfer is completed; wherein the indication originated from the requesting entity; and
updating a ledger for the second account to indicate the resource transfer is completed.

2. The computer-implemented method of claim 1, wherein the particular identifier is a token account number for the second account that does not match an official account number for the second account, and wherein the token account number is valid for completing the resource transfer between the first account and the second account but not valid for one or more other resource transfers with the second account; wherein the official account number for the second account is valid for the one or more other resource transfers with the second account, the computer-implemented method further comprising:
processing the received indication to post the resource transfer against the official account number for the second account based at least in part on determining the token account number is associated with the second account; and invalidating the token account number after receiving the indication that the resource transfer is completed, and wherein the official account number for the second account is not invalidated after receiving the indication that the resource transfer is completed.

3. The computer-implemented method of claim 1, wherein the received indication that the resource transfer is completed identifies a token account number for the first account that does not match an official account number for the first account, and wherein the token account number is valid for completing the resource transfer between the first account and the second account but not valid for one or more other resource transfers with the first account; wherein the official account number for the first account is valid for the one or more other resource transfers with the first account, the computer-implemented method further comprising:
posting, by the requesting entity, the resource transfer against the official account number for the first account based at least in part on determining the token account number is associated with the first account; and
invalidating, by the requesting entity, the token account number after receiving the indication that the resource transfer is completed, and wherein the official account number for the first account is not invalidated after receiving the indication that the resource transfer is completed.

4. The computer-implemented method of claim 1, wherein the resource transfer is completed without making an existing official and re-usable account number of the second account accessible to an owner of the first account and without making an existing official and re-usable account number of the first account accessible to an owner of the second account.

5. The computer-implemented method of claim 1, wherein the second namespace of the second resource handle is specified as a suffix to the second resource handle; wherein the first information comprises a first resource handle; wherein a first namespace of the first resource handle is specified as a suffix to the first resource handle; wherein the first namespace is managed by a first account management institution associated with the requesting entity; and wherein the second namespace is managed by a second account management institution associated with the management entity.

6. The computer-implemented method of claim 1, wherein the second account is stored in association with different resource handles that have different conditions associated with the different resource handles that must be satisfied in order to approve resource transfers using the different resource handles.

7. The computer-implemented method of claim 1, wherein the first information is a first resource handle; wherein the first account is stored in association with different resource handles that have different conditions associated with the different resource handles; wherein at least one of the different resource handles would not satisfy the one or more stored conditions specified for and stored in association with the second resource handle even though the first resource handle does satisfy the one or more stored conditions.

8. The computer-implemented method of claim 1, wherein the received indication that the resource transfer is completed identifies a token account number for the second account that does not match an official account number for the second account, and wherein the token account number is valid for completing the resource transfer between the first account and the second account but not valid for one or more other resource transfers with the second account; wherein the official account number for the second account is valid for the one or more other resource transfers with the second account, the computer-implemented method further comprising:
posting, by the management entity, the resource transfer against the official account number for the second account based at least in part on determining the token account number is associated with the second account.

9. The computer-implemented method of claim 8, wherein a plurality of token account numbers are stored in association with the second account, and wherein different token account numbers of the plurality of token account numbers are valid for transactions satisfying different configurable conditions stored in association with the second account.

10. The computer-implemented method of claim 1, wherein a plurality of resource handles are stored in association with the first account, and wherein different resource handles of the plurality of resource handles are valid for transactions satisfying different configurable conditions stored in association with the first account.

11. The computer-implemented method of claim 5, wherein the first account management institution manages mappings between tokenized account identities and resource handles for a first set of underlying account identities opaquely to the second account management institution, and wherein the second account management institution manages mappings between tokenized account identities and resource handles for a second set of underlying account identities opaquely to the first account management institution.

12. A system comprising:
one or more processors; and
one or more non-transitory computer-readable media storing instructions, which, when executed by the system, cause the system to perform a set of actions comprising:
receiving a request to perform a resource transfer between a first account and a second account, wherein the request originates from a requesting entity and identifies:
first information sufficient to initiate a transaction with the first account,
a second resource handle for the second account without specifying an identity of the second account, and
a requested amount of a resource to be transferred to or from the second account;
wherein the request is routed to a management entity for the second account based at least in part on a second namespace of the second resource handle;
processing the request by the management entity for the second account at least in part by identifying, by the management entity, the second account mapped to the second resource handle based at least in part on a mapping stored privately by the management entity and not shared with or accessible to the requesting entity;
accessing one or more stored conditions specified for and stored in association with the second resource handle; wherein the one or more stored conditions are based on one or more characteristics other than the identity of the first account, and wherein the one or more characteristics are required to have one or more values that must be satisfied in order to approve the resource transfer;
based at least in part on determining the one or more stored conditions are satisfied:
storing, in association with the second account, information to indicate the resource transfer is in process;
transmitting, to the requesting entity, a particular identifier for the second account, wherein the particular identifier is valid for completing the resource transfer between the first account and the second account;
receiving an indication that the resource transfer is completed; wherein the indication originated from the requesting entity; and
updating a ledger for the second account to indicate the resource transfer is completed.

13. The system of claim 12, wherein the resource transfer is completed without making an existing official and re-usable account number of the second account accessible to an owner of the first account and without making an existing official and re-usable account number of the first account accessible to an owner of the second account.

14. The system of claim 12, wherein the second namespace of the second resource handle is specified as a suffix to the second resource handle; wherein the first information comprises a first resource handle; wherein a first namespace of the first resource handle is specified as a suffix to the first resource handle; wherein the first namespace is managed by a first account management institution associated with the requesting entity; and
wherein the second namespace is managed by a second account management institution associated with the management entity.

15. The system of claim 12, wherein the second account is stored in association with different resource handles that have different conditions associated with the different resource handles that must be satisfied in order to approve resource transfers using the different resource handles.

16. The system of claim 12, wherein the first information is a first resource handle; wherein the first account is stored in association with different resource handles that have different conditions associated with the different resource handles; wherein at least one of the different resource handles would not satisfy the one or more stored conditions specified for and stored in association with the second resource handle even though the first resource handle does satisfy the one or more stored conditions.

17. A computer-program product comprising one or more non-transitory machine-readable storage media, including stored instructions configured to cause a computing system to perform a set of actions comprising:
receiving a request to perform a resource transfer between a first account and a second account, wherein the request originates from a requesting entity and identifies:
first information sufficient to initiate a transaction with the first account,
a second resource handle for the second account without specifying an identity of the second account, and
a requested amount of a resource to be transferred to or from the second account;
wherein the request is routed to a management entity for the second account based at least in part on a second namespace of the second resource handle;
processing the request by the management entity for the second account at least in part by identifying, by the management entity, the second account mapped to the second resource handle based at least in part on a mapping stored privately by the management entity and not shared with or accessible to the requesting entity;
accessing one or more stored conditions specified for and stored in association with the second resource handle; wherein the one or more stored conditions are based on one or more characteristics other than the identity of the first account, and wherein the one or more characteristics are required to have one or more values that must be satisfied in order to approve the resource transfer;
based at least in part on determining the one or more stored conditions are satisfied:
storing, in association with the second account, information to indicate the resource transfer is in process;
transmitting, to the requesting entity, a particular identifier for the second account, wherein the particular identifier is valid for completing the resource transfer between the first account and the second account;
receiving an indication that the resource transfer is completed; wherein the indication originated from the requesting entity; and
updating a ledger for the second account to indicate the resource transfer is completed.

18. The computer-program product of claim 17, wherein the resource transfer is completed without making an existing official and re-usable account number of the second account accessible to an owner of the first account and without making an existing official and re-usable account number of the first account accessible to an owner of the second account.

19. The computer-program product of claim 17, wherein the second namespace of the second resource handle is specified as a suffix to the second resource handle; wherein the first information comprises a first resource handle; wherein a first namespace of the first resource handle is specified as a suffix to the first resource handle; wherein the first namespace is managed by a first account management institution associated with the requesting entity; and wherein the second namespace is managed by a second account management institution associated with the management entity.

20. The computer-program product of claim 17, wherein the second account is stored in association with different resource handles that have different conditions associated with the different resource handles that must be satisfied in order to approve resource transfers using the different resource handles.
